(19) United States
(12) Patent Application Publication
(10) Pub. No.: US 2021/0147107 A1
(43) Pub. Date: May 20, 2021

(54) Container Having Wrap-Releasing Texturized Surface

(71) Applicant: Converter Manufacturing, LLC, Orwigsburg, PA (US)

(72) Inventor: Millard F. Wallace, Orwigsburg, PA (US)

(73) Assignee: Converter Manufacturing, LLC, Orwigsburg, PA (US)

(21) Appl. No.: 16/459,217

(22) Filed: Jul. 1, 2019

Related U.S. Application Data
(60) Provisional application No. 62/817,378, filed on Mar. 12, 2019.

(51) Int. Cl. B65D 1/40; B65D 1/34; B29C 33/42

(52) U.S. Cl. CPC B65D 1/40; B29L 2031/712; B29C 33/42; B65D 1/34

(57) ABSTRACT

The disclosure relates to plastic containers which can be wrapped in and/or contacted with plastic films such as cling films. The containers contact the film at at least one surface that is texturized sufficiently to reduce friction (i.e., reduce resistance to slippage of the film across the texturized surface). Owing to the reduced resistance to slippage, the film can move relative to the portion of the container which it contacts, such as when the film rubs against another object. Such relative movement facilitates stretching or displacement of the film and reduces tears, necking, and holes in the film when a film-wrapped container contacts other objects. As a result, line speeds can be faster and less care can be exercised in packing and other handling operations. The texture can be conferred to one or more portions of the container during molding, or prior to or after molding.

### CROSS-REFERENCES TO RELATED APPLICATIONS

This application is entitled to priority to U.S. provisional patent application No. 62/817,378 filed 12 Mar. 2019.

### BACKGROUND OF THE DISCLOSURE

The invention relates generally to the field of using thin plastic films to wrap containers.

Thin plastic films have been used for many years to package products within container such as trays, bins, buckets, and plates. Among the properties of plastic films that make them amenable for use in combination with containers is that they tend to be thin, inexpensive, and simple to apply to containers. A significant disadvantage of plastic films used for containing products within containers is that the films can tear. Once even a small tear is generated in a plastic sheet, the tear can often rapidly propagate through the sheet in at least one dimension, especially in sheets in which polymer strands tend to be directionally oriented.

Tears in films can permit liquids, gases, filth, bacteria, and/or insects to cross the package boundary. If the tear is sufficiently large, or if it propagates, the contents of the package can be lost as well. When plastic films are used to maintain sterility or low bacterial load of container contents, such as in food-packaging operations, a tear in a packaging film can render the contained product unhealthful or non-salable, even if the tear does not permit significant release of the product from the package. Product release from torn packages can also disrupt or contaminate packaging and shipping operations, incurring additional expense and disruption. The benefits of avoiding tears in packaging films are therefore well known and significant.

Several plainly-apparent mechanisms are known to tear polymer sheets, including penetration by sharp points and edges, extreme stretching, and localized application of high heat. These mechanisms tend to be relatively simple to avoid, for example by removing sharp points and edges from the vicinity of plastic films and limiting processing forces (e.g., in container-wrapping machinery) and heat sources so as to avoid generation of forces or film weaknesses sufficient to result in sheet puncture, stretching, or melting. However, there exists a large category of circumstances in which tears in packaging films are observed despite the absence of sharp edges or extreme processing forces.

Film-closed packages (e.g., high-walled plastic bins having their openings sealed at the wall edges with a plastic film or cuts of poultry placed upon plastic trays and sealed with a plastic overwrap which clings thereto) have been observed to develop film tears when they are contained within larger shipping containers (e.g., cardboard boxes or plastic bags containing the film-closed packages), for example. Similarly, tears are often observed among film-wrapped trays moved through high-speed or high-volume processing machinery such as conveyor belts, spiral freezers, and container packers. The origins of tears which occur in these operations are often not well understood.

Anecdotal evidence suggests that the frequency of such unexplainable tears has increased as film-sealed packaging materials have shifted from paperboards and foamed plastics to solid (i.e., non-foamed) plastic packaging materials. Solid plastic packaging materials exhibit beneficial characteristics including inexpensiveness, ease and reliability of handling (especially in high-speed packaging processes), and recyclability. However, these benefits are greatly lessened if they are offset by increased incidence of packaging film tears.

One way of reducing unexplained tears in packaging films would be to greatly strengthen plastic films or add chemical agents to films to beneficially affect their flexibility and/or slickness. There are at least two significant drawbacks to such procedures, however. First, current packaging and handling processes have been designed with existing film properties in mind, and reformulation of films would likely require redesign of those processes. Second, films used for packaging of foodstuffs must comply with relatively stringent regulations regarding health, safety, and reliability. Addition of chemical agents to existing films would require significant study and testing to ensure that the films remain compatible with food packaging operations.

It would therefore be beneficial if solid plastic trays, plates, bins, and other containers could be made which will not exhibit the sealing-film-tearing tendencies that such containers have too often exhibited in the past. Furthermore, it would be beneficial if improved containers could be made which do not incorporate additional chemical agents, which would involve many of the same drawbacks as additional agents in films.

The present disclosure describes such containers and methods of making them.

### BRIEF SUMMARY OF THE DISCLOSURE

The disclosure relates to containers for containing an article in a film-wrapped package at a handling temperature. Such a container includes a substantially rigid thermoplastic sheet formed into the shape of the container and bearing a texturized portion at a film-contact surface of the container. The container can be, for example, a container having a base adapted to support the article and one or more sidewalls which surround the base and are not coplanar with the base, the sidewalls having an outer peripheral extent.

The texturized portion of the container should have a surface texture which wets with not more than 80 percent (and preferably not more than 50 or 25 percent) of the film surface that is opposed against the texturized portion when the container is wrapped with the film at the handling temperature. Alternatively, the texturized portion should have a surface texture which wets with at least 20 percent less (or at least 50 or 75 percent lest) of the film surface than an otherwise-identical non-texturized portion. Viewed another way, the texturized portion should have a surface texture that facilitates free lateral gas movement along the surface when a gas-impermeable film is applied to the texturized portion. Yet another way of quantifying this is that the texturized portion should have a surface texture selected such that the frictional force opposing lateral slippage of the film at the texturized portion when the container is wrapped with the film at the handling temperature is reduced by at least 20 percent (or 50 or 75 percent), compared with the frictional force opposing lateral slippage of the film at the texturized portion of an otherwise identical container having a substantially smooth texture at the texturized portion.

The containers are envisioned to be particularly useful for wrapping or sealing with cling films, such as PVC- or LDPE-based cling films.

In some embodiments, the container is made from a thermoplastic sheet that is or includes PET. The shape of the container is not critical, and can, for example, be one which has the conformation of a rectangular tray having rounded corners and/or bears a smooth peripheral edge. The peripheral edge of the container can be curled.

The surface texture of the texturized portion can be substantially isotropic, such as an impression of a particle-blasted mold surface. Alternatively, the surface texture of the texturized portion can be an impression of a machined mold surface. The surface texture preferably includes steep asperities over at least 10 percent of the area of the texturized portion.

Preferably, substantially all film-contact surfaces of the container bear the texturized portion.

The disclosure also relates to molds for making plastic containers amenable for wrapping with a plastic film. The mold includes a mold body bearing mold surfaces for molding a plastic applied thereto into the container, the mold surfaces including a texturized portion for conferring a texture to a film-contact surface of the container. The mold the texturized portion of the mold can bear a pitted surface, or a patterned surface (e.g., an anisotropic patterned surface). The mold can be a thermoforming mold or an injection mold, for example.

The disclosure also relates to a method of making a container for containing an article within a film-wrapped package. The method includes the steps of i) texturizing a portion of a mold for making the container, and then ii) molding a plastic using the mold to yield the container. The texturized portion should correspond to a film-contact surface of the container and being texturized to confer a surface texture to the film-contact surface.

The disclosure also relates to a method of making a mold for forming containers useful for containing an article within a film-wrapped package. The method includes the steps of i) making a mold for forming containers for containing the article and then ii) texturizing a portion of the mold corresponding to a film-contact surface of the container prior to forming containers using the mold.

### BRIEF SUMMARY OF THE SEVERAL VIEWS OF THE DRAWINGS

FIGS. 1A, 1B, 1C, 1D, and 1E illustrate interactions among plastic tray surfaces and flexible sheets of film. FIG. 1A illustrates the surface of a portion of a plastic tray (T1) having a sheet of flexible cling film (S1) associated with it. “Lightning bolt” symbols indicate that binding forces attract the sheet S1 to the surface of the tray T1 in a manner capable of impeding lateral movement of sheet S1 across the surface of tray T1. FIG. 1B illustrates a situation in which two cling-film-wrapped trays (T1 and T2) contact one another, with the identical cling film sheets (S1 and S2) associated with the trays binding with each other more strongly (higher density of “lightning bolt” symbols) than with their associated trays. Shown in FIG. 1B are reference points R1 (a point at which, or collectively to the right of which, film S1 binds sufficiently strongly to tray T1 to inhibit slipping of the film along the tray surface) and R2 (a point on film S1 that moves with tray T2, owing to binding between films S1 and S2). The distance between R1 and R2 is distance L. FIG. 1C shows the trays of FIG. 1B after tray T2 has been moved a distance of 0.2×L to the left, relative to FIG. 1B. Because R2 moves with tray T2, the distance between R1 and R2 is now 1.2 L. In FIG. 1C, film S1 has become elastically stretched between R1 and R2. FIG. 1D shows the trays after tray T2 has been moved a distance of 0.5×L to the left, relative to FIG. 1B. Because R2 moves with tray T2, the distance between R1 and R2 is now 1.5 L. In FIG. 1D, film S1 has become inelastically stretched between R1 and R2, as evidence by necking exhibited in this region. FIG. 1E shows the trays after tray T2 has been moved a distance of L to the left, relative to FIG. 1B. The distance between R1 and R2 is now 2 L. In FIG. 1E, film S1 has been stretched so much between R1 and R2 that the film has ruptured.

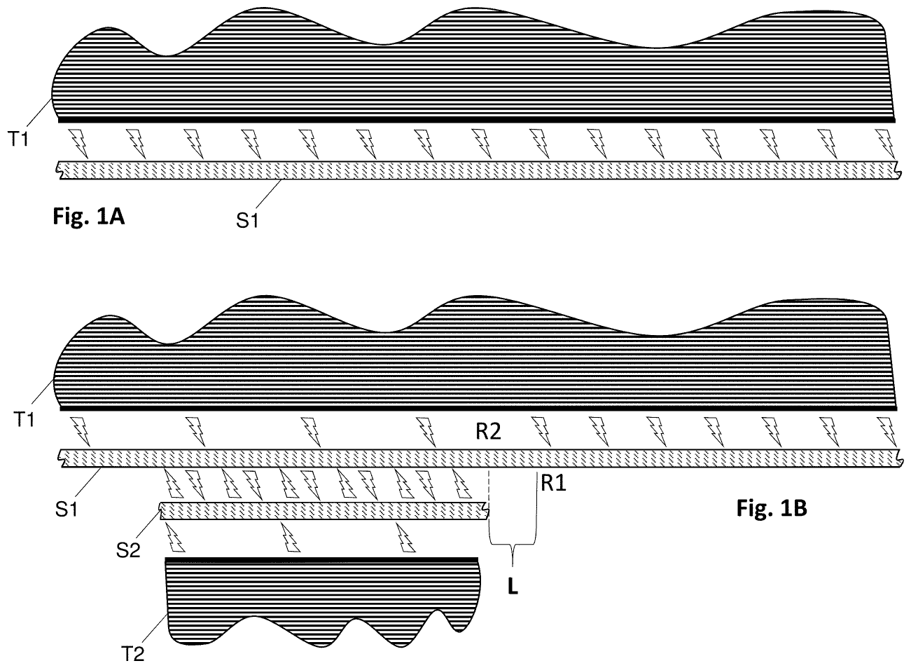

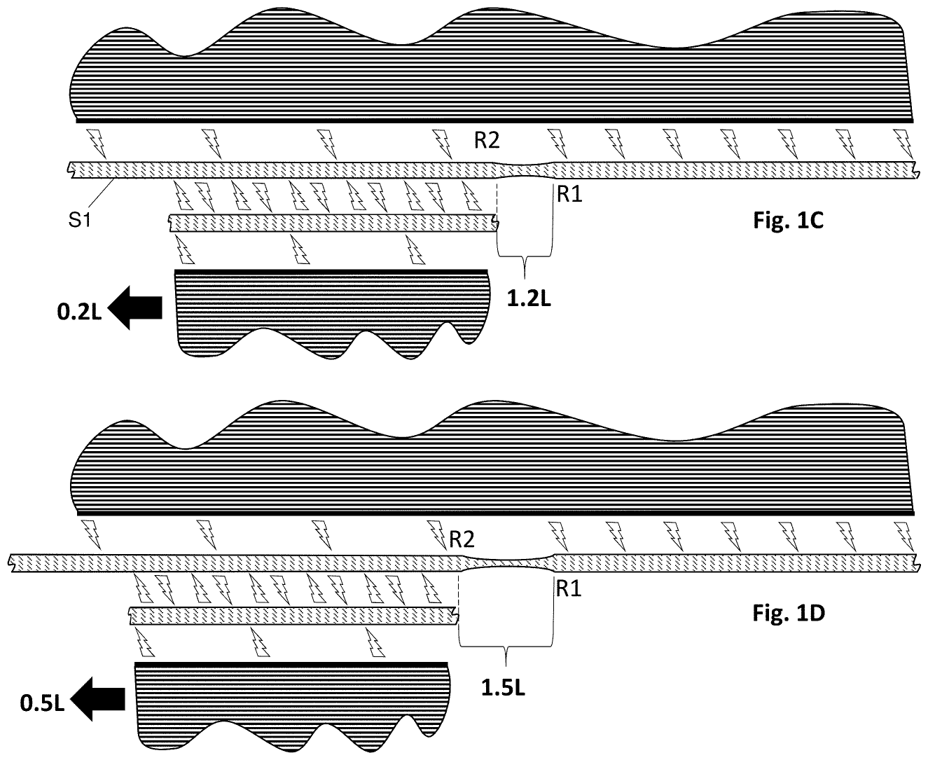

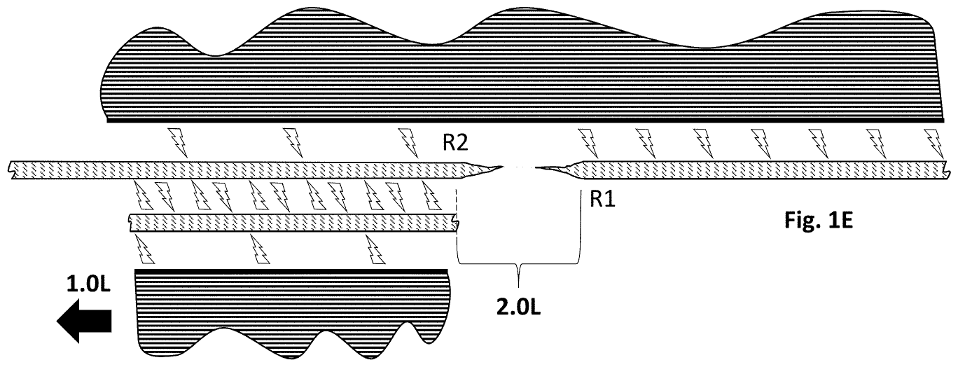

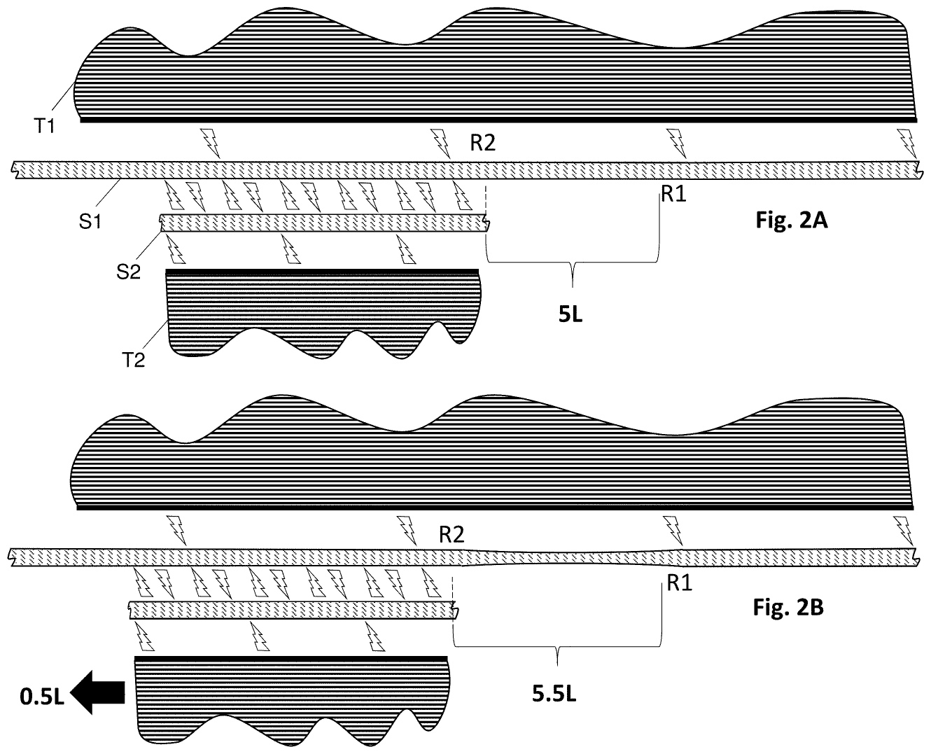

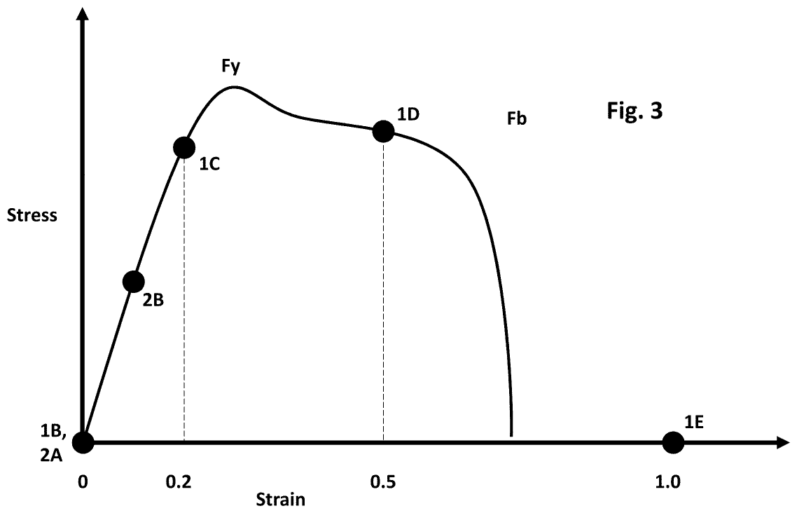

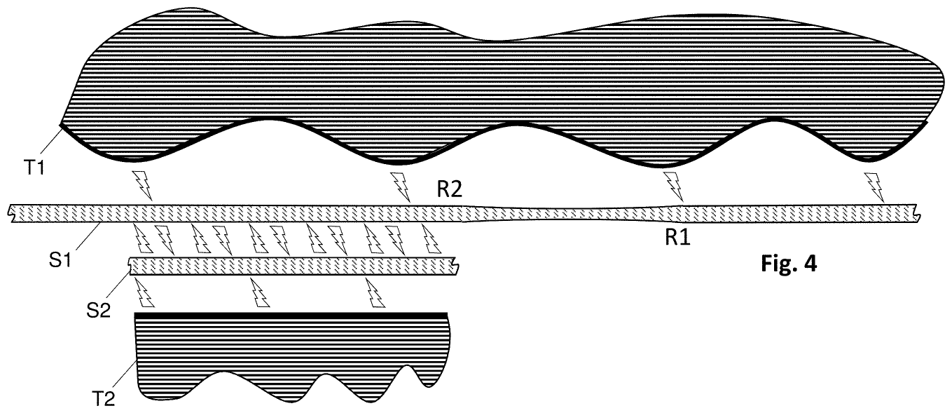

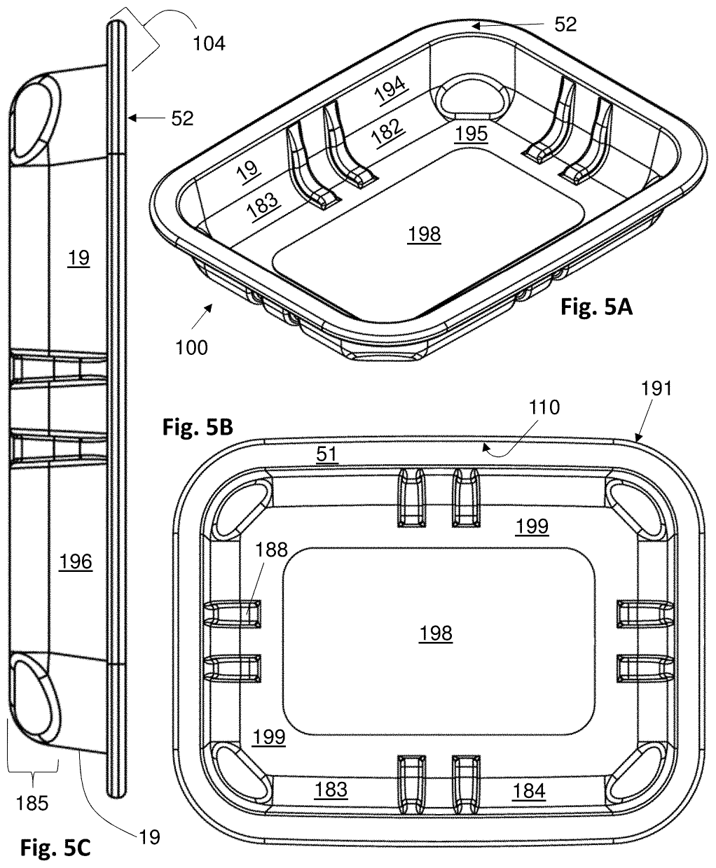

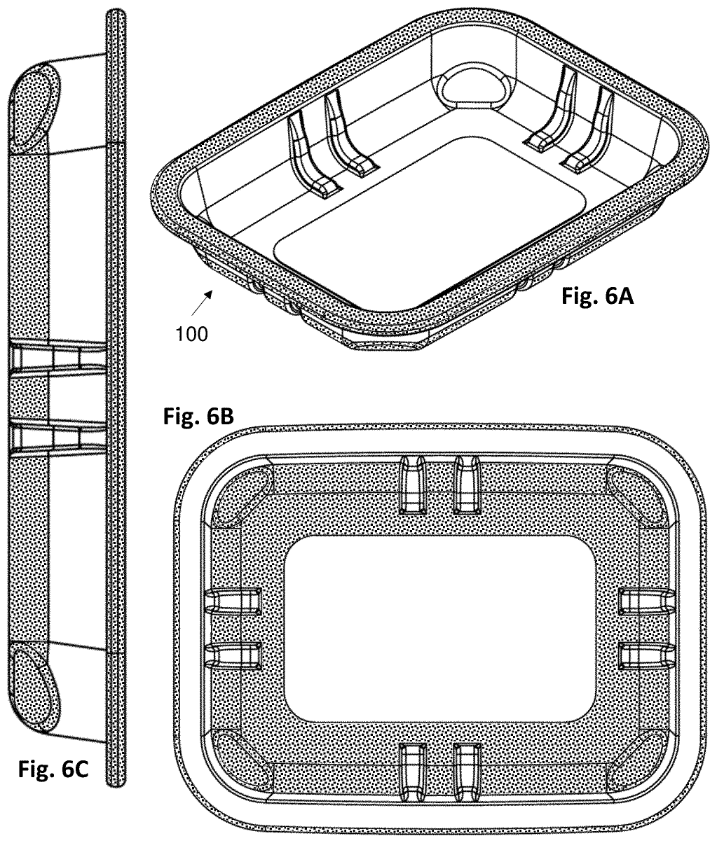

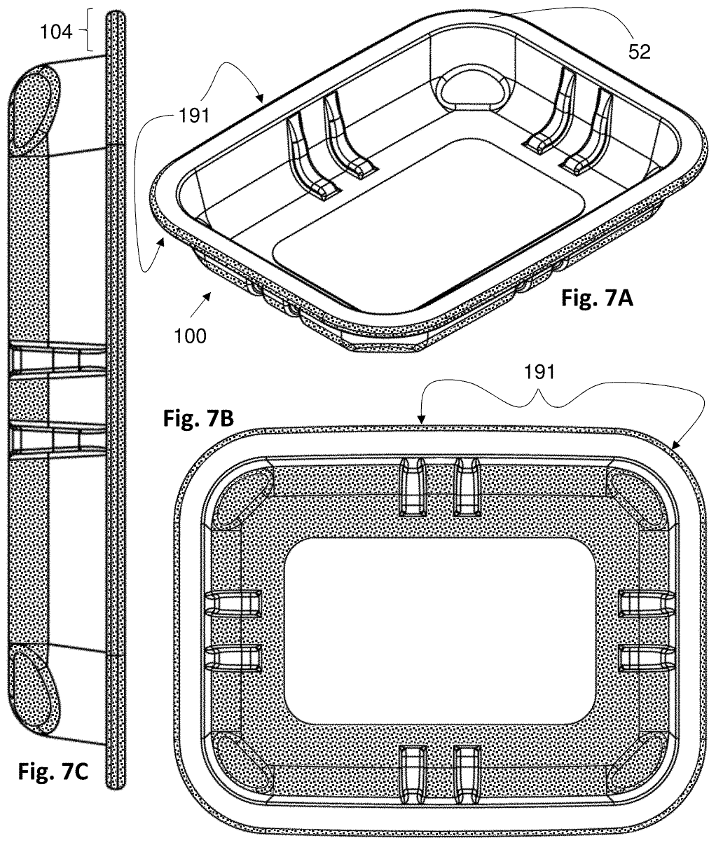

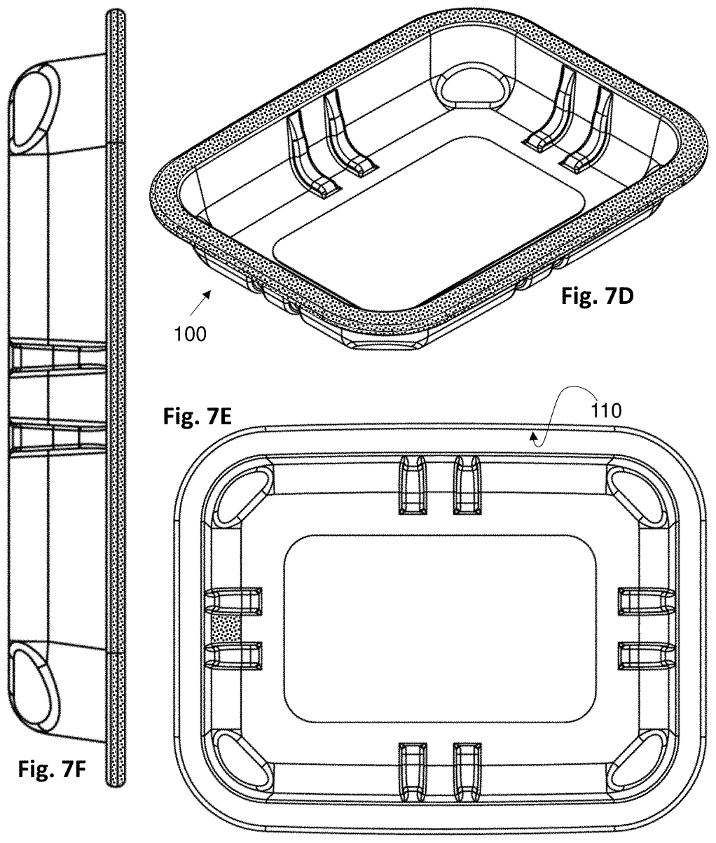

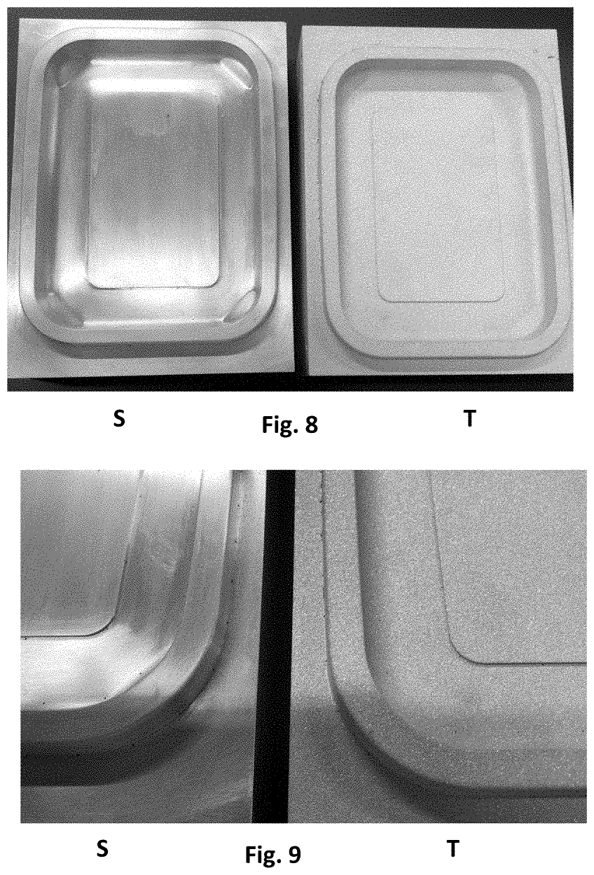

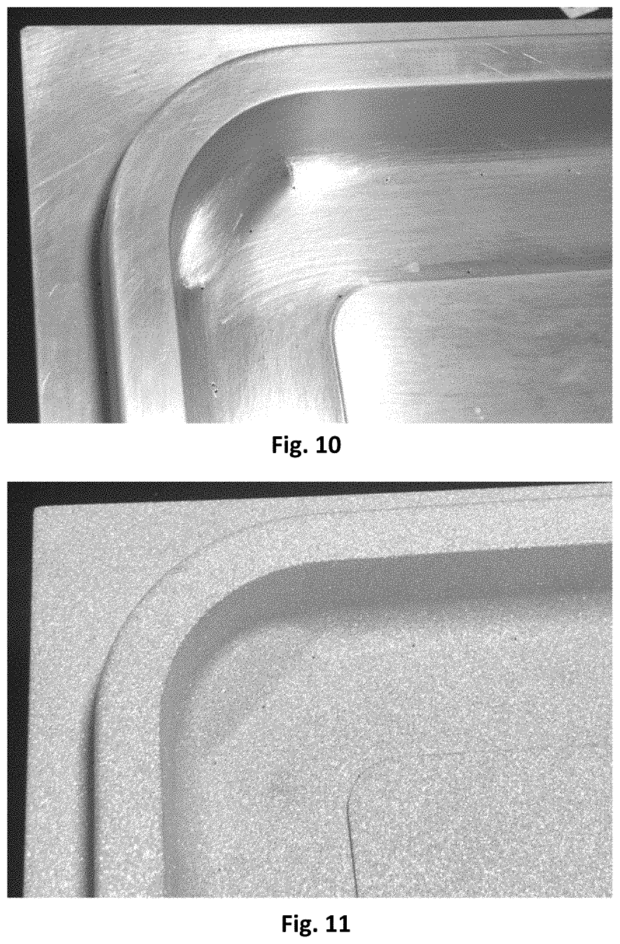

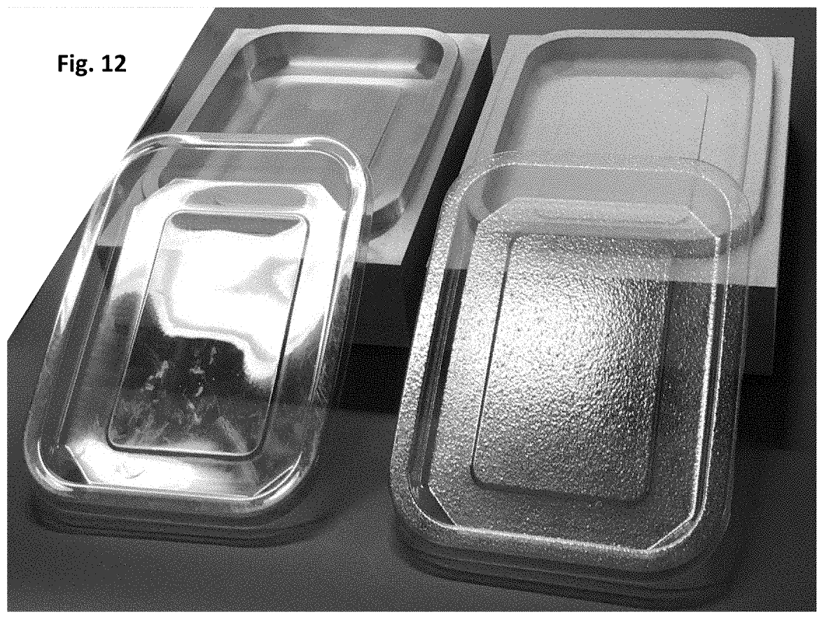

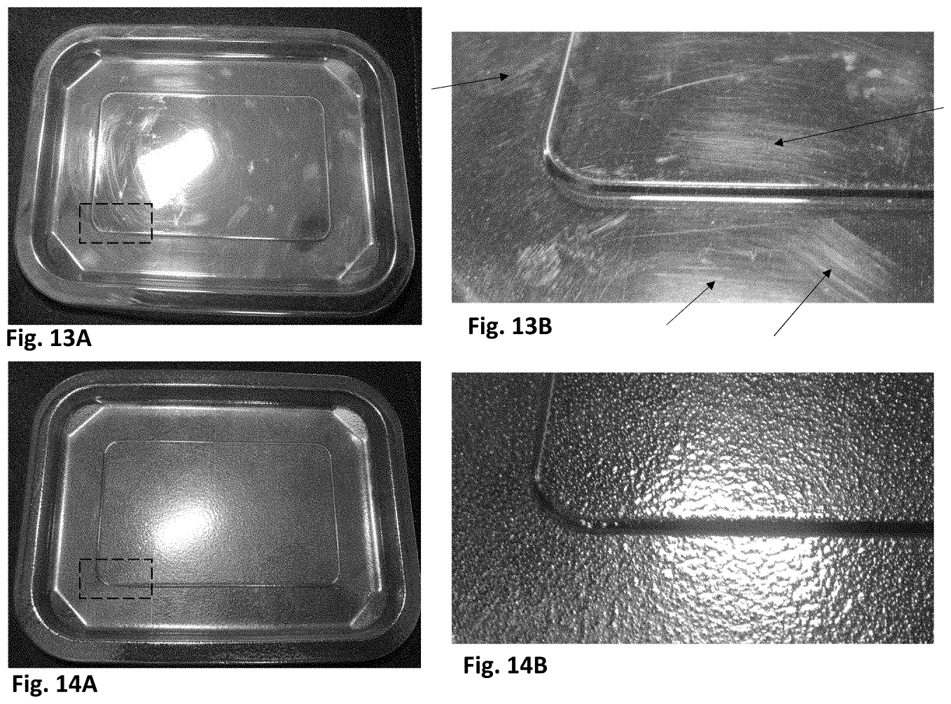

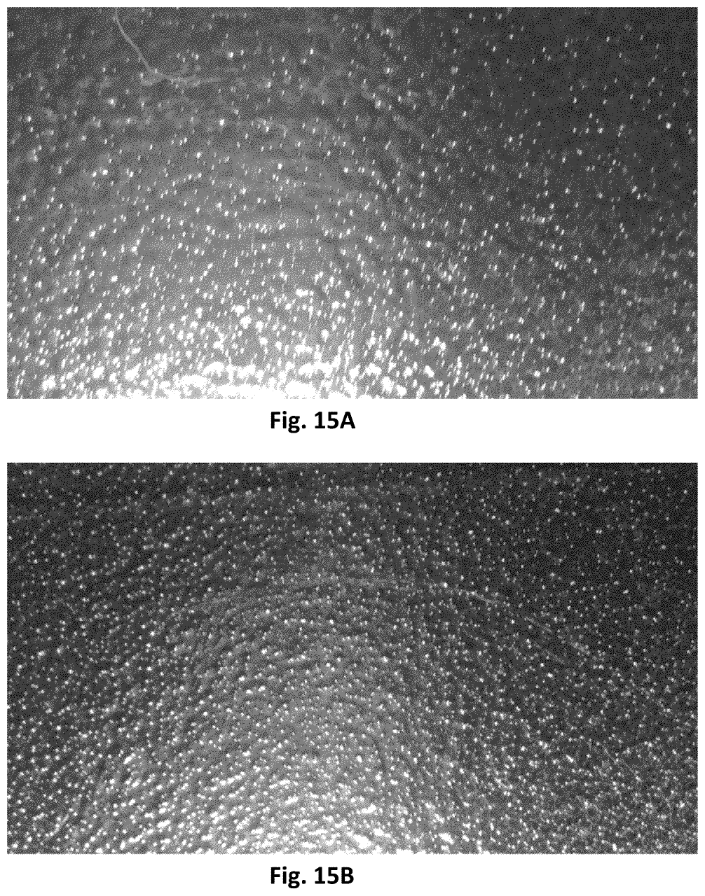

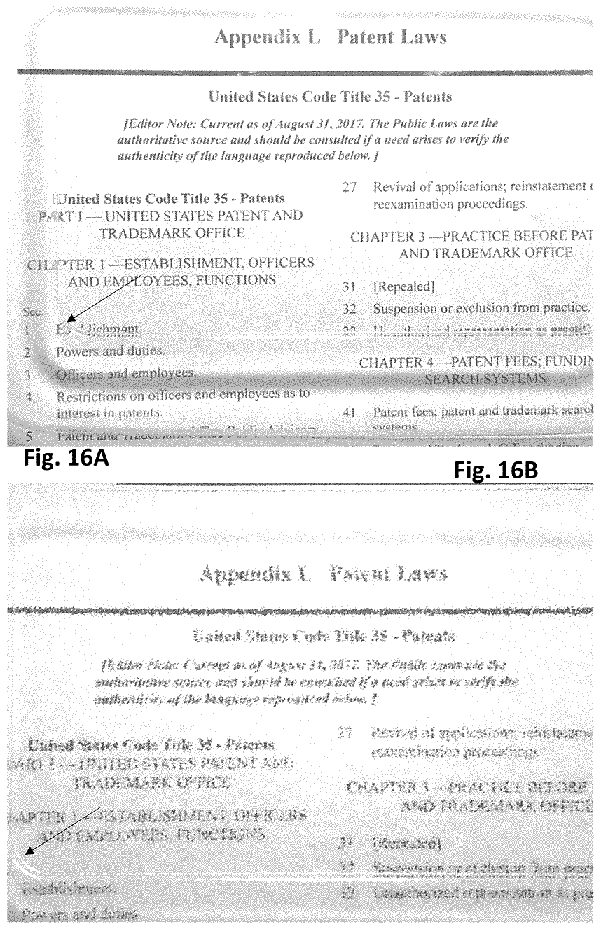

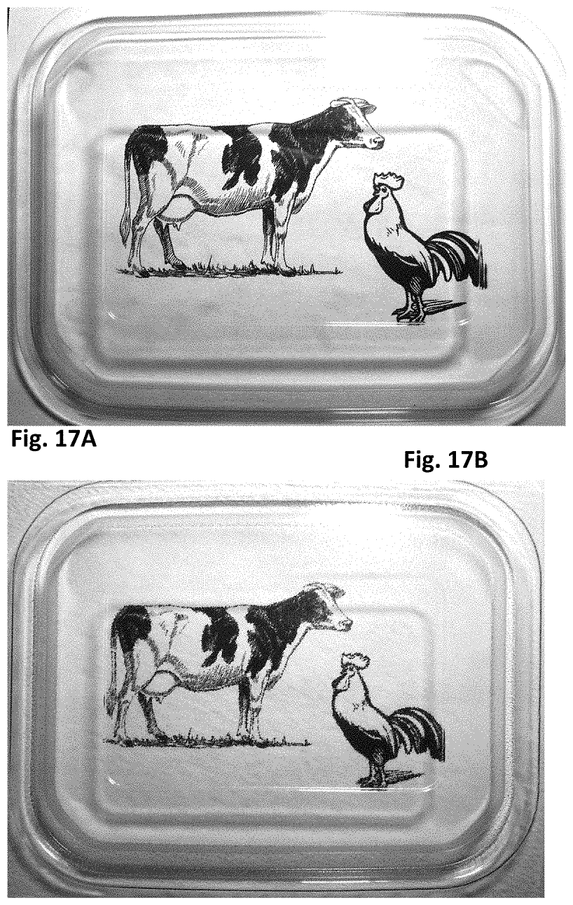

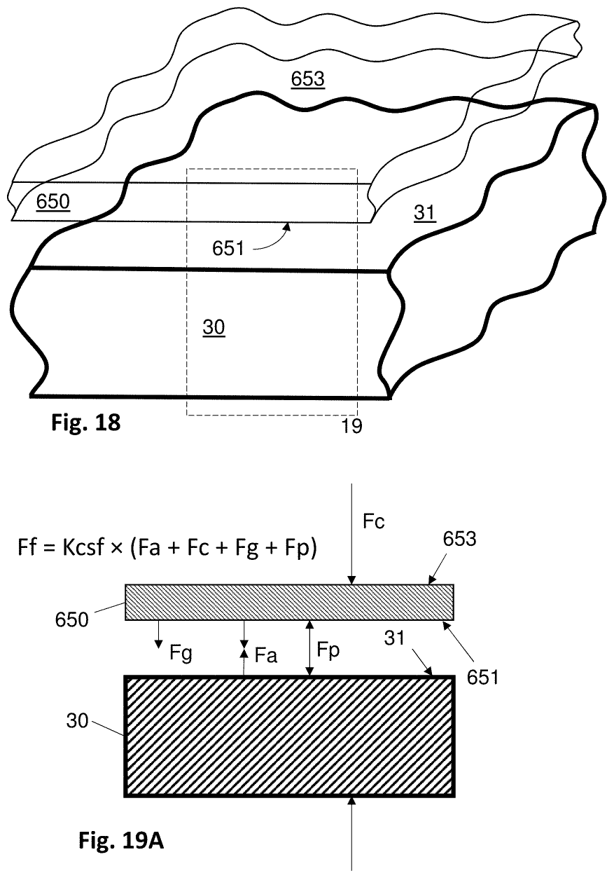

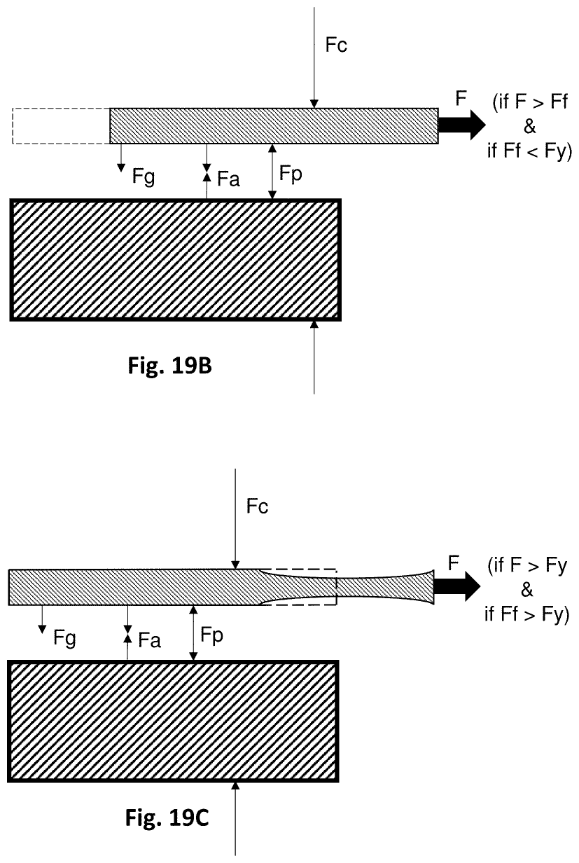

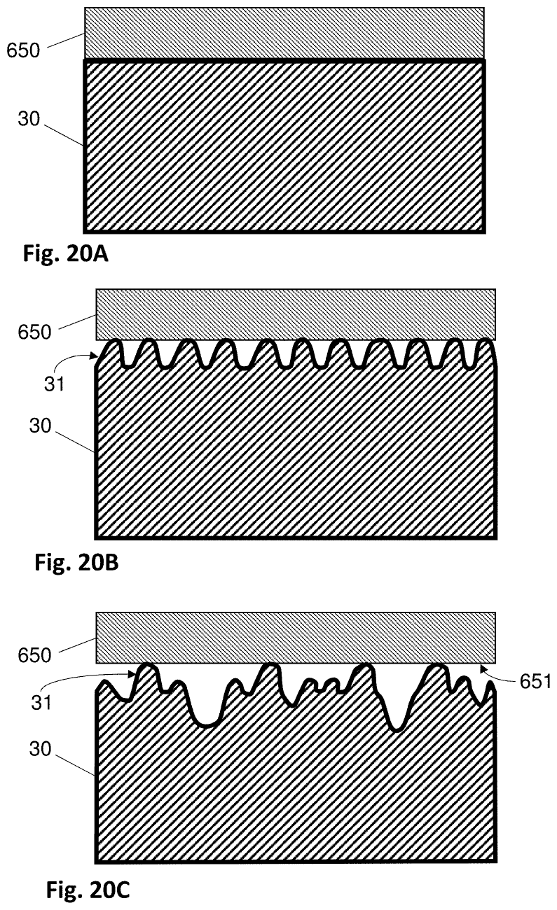

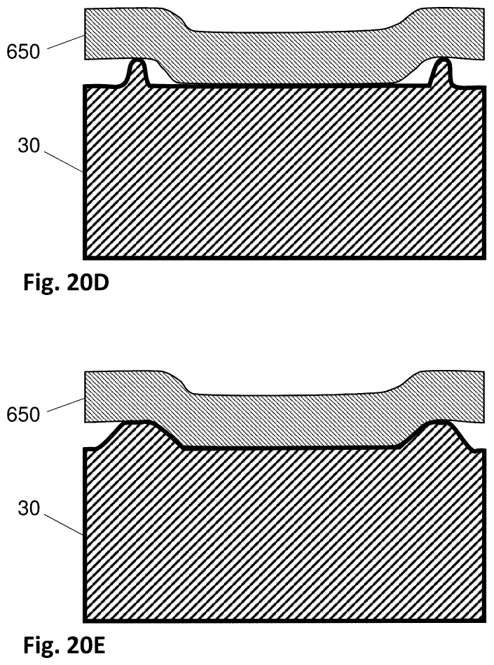

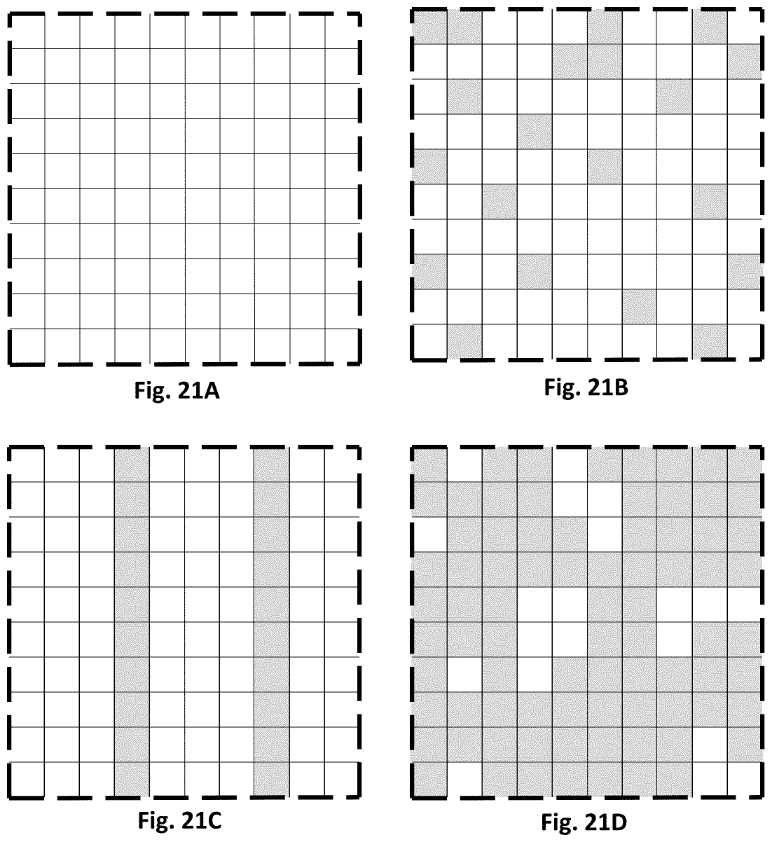

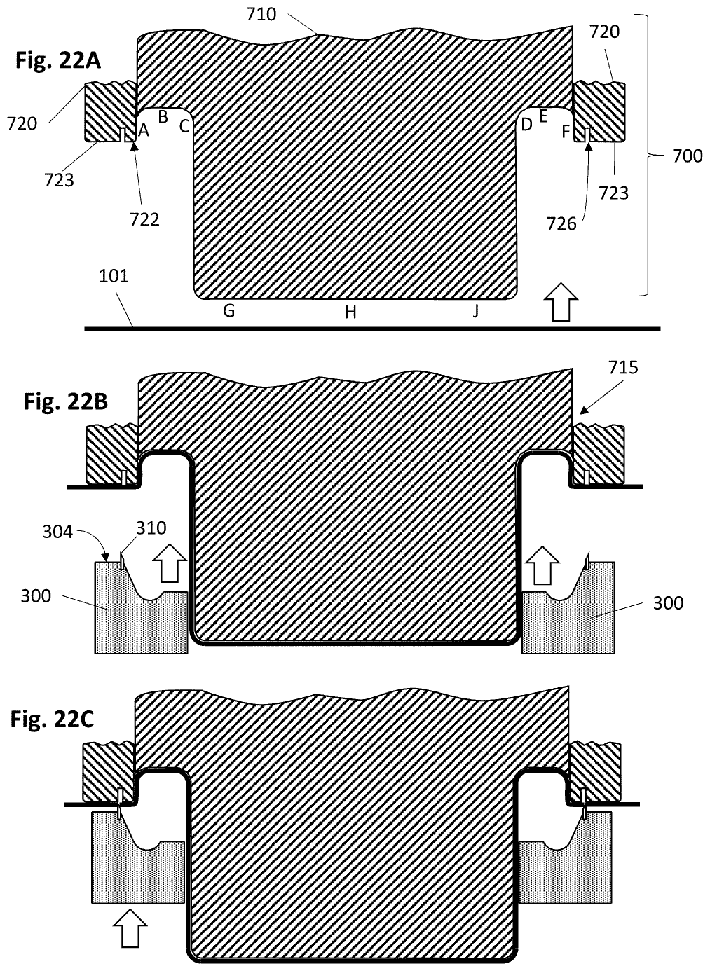

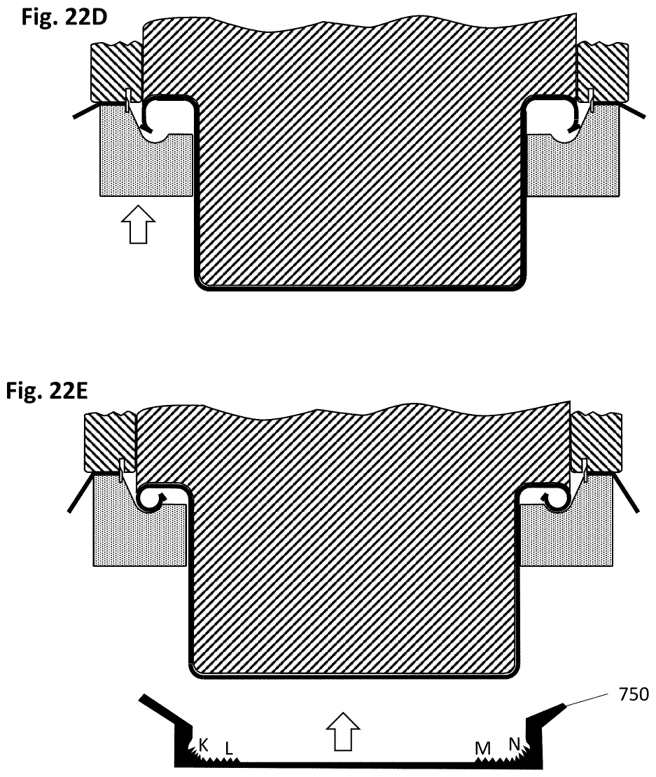

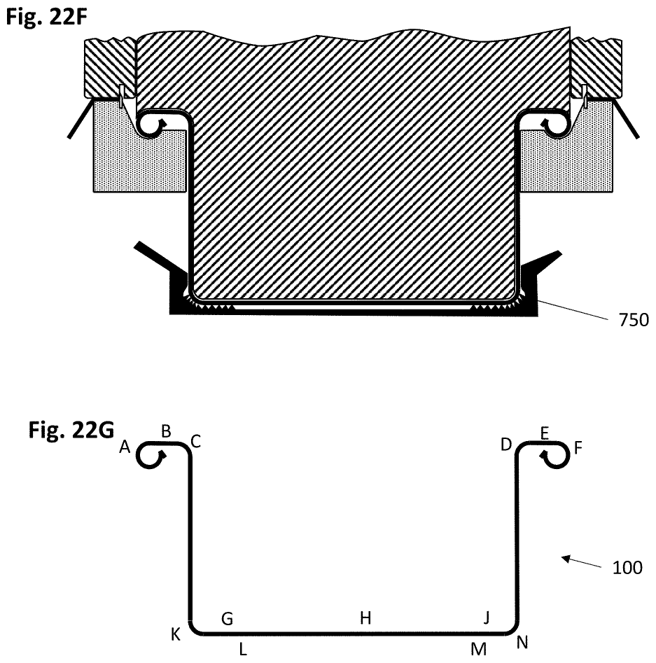

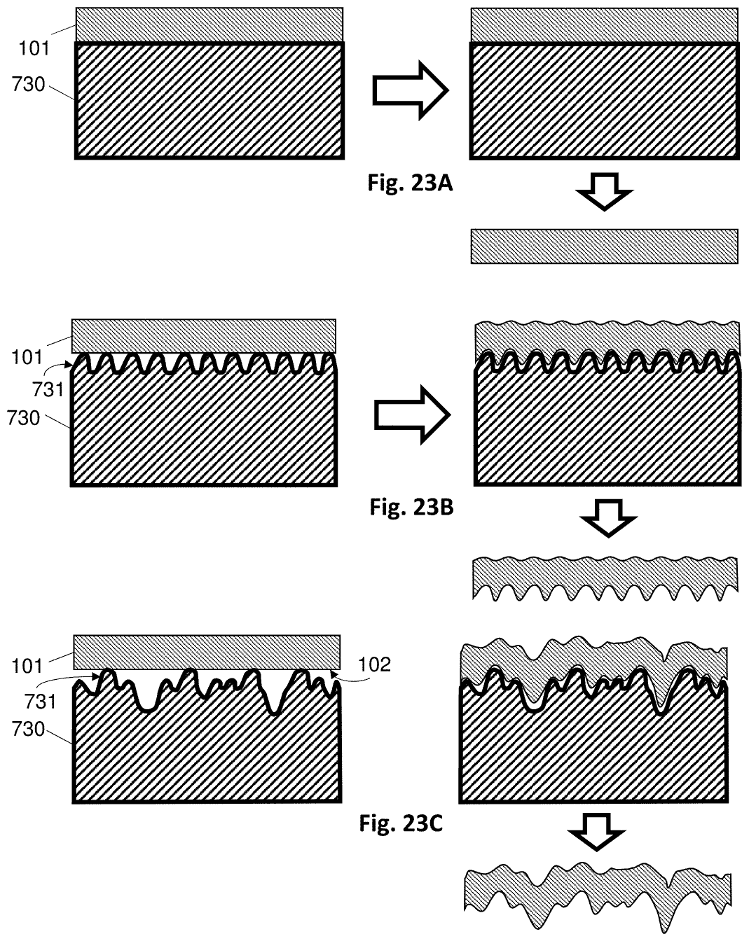

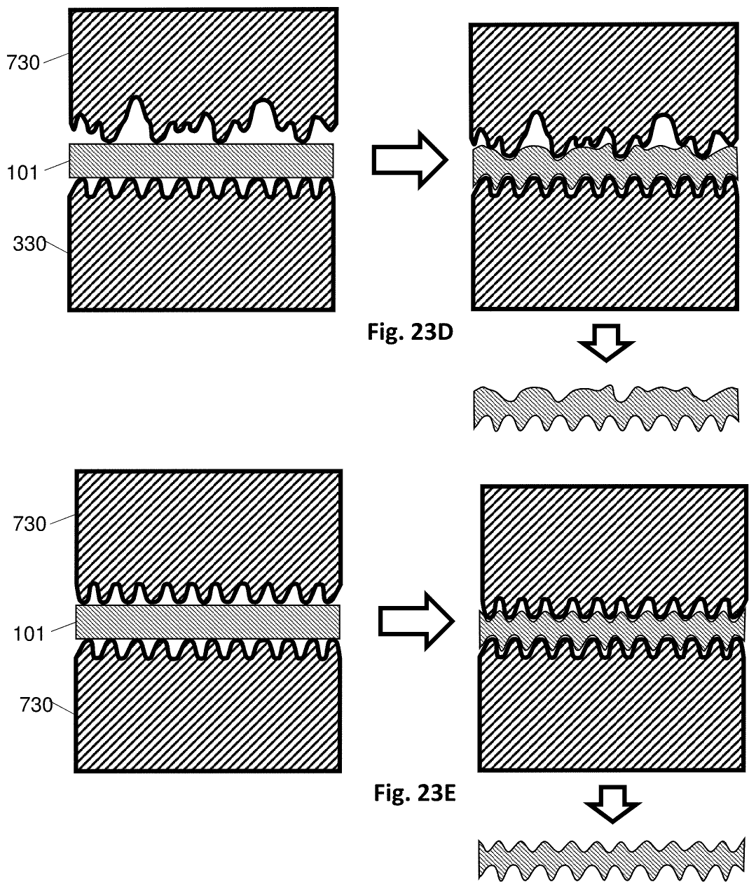

Each of FIGS. 2A and 2B, like FIGS. 1A-1E, illustrates interactions among plastic tray surfaces and flexible sheets of film. Tray T1 is made from a material less attractive to film S1 than the material of tray T1 in FIGS. 1A-1E. This lesser-attraction is represented in the FIGS. 2A and 2B in that the density of attraction (“lighting bolt” symbols) between tray T1 and film S1 in FIGS. 2A and 2B 2 is shown as being significantly less than in FIGS. 1A-1E. As a result, the distance between R1 and R2 will tend to be significantly larger, here illustrated as 5L (as shown in FIG. 2A). When tray T2 and its associated film S2 are moved 0.5 L to the left (as shown in FIG. 2B and as in FIG. 1D, the film is only elastically stretched (analogously to the stretching shown in FIG. 1C, when the tray was moved only 0.2 L to the left).

FIG. 3 is a stress-strain diagram for the film illustrated in FIGS. 1A-1E, 2A, and 2B. Between strain values of 0 and a little more than 0.2, the film stretches elastically, as occurs in FIGS. 1C and 2B. Between strain values greater than 0.2 and less than about 0.75, the film stretches inelastically, as in FIG. 1D. At strain values greater than about 0.75, the film ruptures, as in FIG. 1E. Although the stress-strain diagram (like the film) is hypothetical, it is analogous to the stress-strain diagrams of well-known cling films.

FIG. 4 is an illustration analogous to FIGS. 1A-1E, 2A, and 2B. The material used to make tray T1 in FIG. 4 is the same as that of tray T1 in FIGS. 1A-1E, and the material of film S1 is identical to S1. T1 and S1 would exhibit the same density of attraction as shown in FIGS. 1A-1E, except that the surface of tray T1 has been texturized, effectively reduce the area of contact between T1 and S1 and accordingly reducing the density of attraction to a level analogous to that between tray T1 and S1 in FIGS. 2A and 2B. This illustrates that texturization of the tray surface can have a similar film-slip-enhancing effect as changing the composition of the tray and/or the film.

FIGS. 5A, 5B, and 5C are perspective (FIG. 5A), bottom-side (FIG. 5B), and right-side (FIG. 5C) views of a tray which has a rolled-over edge and flat rim and which is useful for any of OW, MAP, or VSP techniques (over-wrap, modified atmosphere packaging, and vacuum sealed packaging) sealing of articles therein.

FIGS. 6A, 6B, and 6C are views of the tray shown in FIGS. 5A-5C (i.e., perspective view in FIG. 6A, bottom-side view in FIG. 6B, and right-side view in FIG. 6C), wherein the surface of the tray has been texturized as described in greater detail herein. The tray shown in FIGS. 6A-6C has a texturized surface at substantially all surfaces at which an over-wrapped cling film can normally be expected to contact the tray surface.

FIGS. 7A, 7B, 7C, 7D, 7E, and 7F are views of the tray shown in FIG. 5A-5C (i.e., top perspective view in FIGS. 7A and 7D, bottom view in FIGS. 7B and 7E, and side view in FIGS. 7C and 7F), wherein the surface of the tray has been texturized as described in greater detail herein. The tray shown in FIGS. 7A (top perspective view), 7B (bottom view), and 7C (side view) has a texturized surface at substantially all surfaces at which an over-wrapped cling film sealed against the edge of the flat portion of the rim can normally be expected to contact the tray surface when a bulky item (one which extends from the bottom interior of the tray to a level above the rim) is carried therein. The tray shown in FIGS. 7D, 7E, and 7F has a texturized surface at surfaces at which an over-wrapped cling film pressed flat against the flat portion of the rim can normally be expected to contact the tray surface when a non-bulky item (one which does not extend above the rim) is contained therein.

FIG. 8 is a comparison of a normal, smooth-surfaced aluminum mold (S) useful for thermoforming a storage tray and a substantially-identical aluminum mold wherein the molding surfaces have been texturized (T) by blasting its surface with aluminum oxide particles to an approximate surface roughness of 16 grit.

FIG. 9 is a closer view of the surfaces of the molds shown in FIG. 8.

FIGS. 10 and 11 are closer views of the surfaces of the molds shown in FIGS. 8 and 9. The smooth mold is depicted in FIG. 10, and the texturized mold is depicted in FIG. 11.

FIG. 12 is an image of trays made using the molds shown in FIG. 8, a smooth-surface tray resting against the smooth-surfaced mold on the left, and a texturized tray resting against the texturized-surface mold.

FIG. 13A is an overhead image of the smooth tray shown in FIG. 12 illuminated by an overhead light to highlight its smooth, shiny surface texture. FIG. 13B is an enlargement of the areas bounded by a dashed box in FIG. 13A. Arrows in FIG. 13B highlight scuff marks visible upon the surface of the smooth tray, attributable to processing and handling of the tray.

FIG. 14A is an overhead image of the texturized tray shown in FIG. 12 illuminated by an overhead light to highlight its irregular surface texture. FIG. 14B is an enlargement of the areas bounded by a dashed box in FIG. 14A. Despite processing and handling of the texturized tray analogous to the processing and handling of the smooth tray shown in FIGS. 13A and 13B, no scuff marks can be seen on the surface of the texturized tray.

FIG. 15A is a close-up view of the surface of the texturized tray which was opposed against the texturized mold surface during thermoforming. FIG. 15B is a close-up view of the surface of the texturized tray which faced away from the texturized mold surface during thermoforming.

FIGS. 16A and 16B are a pair of images which compare the clarity of the smooth and texturized trays shown in FIG. 12. FIG. 16A is an image of text viewed through the smooth tray, and FIG. 16B is an image of the same text viewed through the texturized tray. An arrow in each figure indicates the corner of the text plate of the corresponding tray. These figures illustrate that fine detail can be better viewed through the smooth tray than through the texturized tray.

FIGS. 17A and 17B are a pair of images which compare the clarity of the smooth and texturized trays shown in FIG. 12. FIG. 17A is an image of two images viewed through the smooth tray, and FIG. 17B is an image of the same two images viewed through the texturized tray. These figures illustrate that less-fine detail can be viewed essentially equally well through both the smooth tray and the texturized tray.

FIG. 18 is a diagram that illustrates interaction of a plastic sealing film 650 with a portion 30 of a solid plastic container. The substrate-facing face 651 of the cling film 650 contacts the film-contact surface 31 of the container portion 30 (i.e., the film-facing surface of the substrate). The film 650 is disposed parallel to and along the surface 31, and there is a layer of gas interposed between the film 650 and the surface 31. Wavy lines in FIG. 18 indicate that other portions of the cling film and the container are not shown (i.e., it is a cut-away view). The dashed box in FIG. 18 indicates a plane further detailed in FIGS. 19A-19C.

FIG. 19A is diagram which shows forces acting upon the film 650 and container 30 at their interface. FIGS. 19B and 19C are each diagrams which show potential macroscopic effects of these forces upon movement of the film laterally across the surface 31.

FIGS. 20A, 20B, 20C, 20D, and 20E illustrate several substrate surface texture profiles and effects that textures can have on cling film binding to the substrate. In each of FIGS. 20A-20E, a cross-sectional view of the interface of a cling film 650 and a solid plastic substrate 30 is depicted.

Each of FIGS. 21A, 21B, 21C, and 21D depicts a square portion of the substrate-facing face 651 of a cling film (dashed line surrounding figure), sub-divided into 100 smaller squares in a 10×10 grid (solid lines within figure). Non-shaded squares signify portions of the film that are not closely enough bound with the film-facing surface 31 of the solid plastic substrate 30 for van der Waals interactions to be significant. Shaded squares signify portions of the film bound closely enough with the film-facing surface 31 that significant van der Waals attractive force exists between the film and substrate surfaces.

FIGS. 22A, 22B, 22C, 22D, 22E, 22F, and 22G depict contact between a plastic substrate sheet 101 and one or more of a core mold element 710, a peripheral mold element 720, and a strike plate 750. In FIG. 22A, the substrate sheet 101 is separated from, but moving towards a core mold element 710, and letters adjacent surfaces of the core mold element and peripheral mold element(s) 720 indicate surfaces which may confer texture to the substrate sheet upon close contact. In FIG. 22B, the substrate sheet is molded flush against the core mold element and a peripheral mold element(s). Ram(s) 300 bear knife 310 and are moving toward the substrate sheet. Portions of the substrate sheet are closely opposed against surfaces A, B, C, D, E, F, G, H, and J. In FIG. 22C, the knives cut the substrate sheet, and in FIG. 22D, the ram(s) displace the peripheral mold element(s) and cause rolling of the peripheral flange. Rolling is more advanced in FIG. 22E, and a strike plate 750 is moving toward the substrate sheet, which is already opposed against the core mold element. Surfaces K, L, M, and N of the strike plate bear clear surface textures. In FIG. 22F, the substrate sheet is sandwiched between (i.e., closely opposed against both) the core mold element and the strike plate. The textures at surfaces K, L, M, and N are thereby imposed upon the substrate sheet, as can be seen in FIG. 22G, which shows the substrate sheet after it has been removed from the mold elements and the strike plate. One, more, or all of surfaces A-H and J-N will tend to reflect the texture of the surface against which they were closely opposed.

FIGS. 23A, 23B, and 23C depict cutaway views of a plastic substrate sheet 101 closely opposed against a substantially flat mold surface (FIG. 23A), a substrate-shaping mold surface 730 bearing ridges or bumps at its textured surface 731 (FIG. 23B), or an irregular textured mold surface 731 (FIG. 23C). If the substrate sheet is at or above its glass transition temperature, or heat is applied by the mold surface, the mold-facing surface 102 of the substrate sheet can assume the texture of the mold surface. If the substrate sheet is substantially softened above it GTT, gravitational force, air pressure applied to the substrate face opposite the mold-contacting face 102, or vacuum applied to the mold-contacting face can deform the substrate sheet sufficiently that texture is also conferred to the face of the substrate sheet opposite the mold-contacting face (the mold-contacting face will tend to more closely approximate the texture of the mold face). FIGS. 23D and 23E depict a substrate sheet sandwiched between a pair of mold surfaces to confer a texture (the same textures, as in FIG. 23E, or different textures, as in FIG. 23D) to the opposite faces of the substrate sheet.

### DETAILED DESCRIPTION

The disclosure relates to containers for containing items, such as food items, upon or within a compartment of the container and for sealing the container with plastic film. The containers described herein have one or more texturized surfaces and exhibit substantially less tearing of sealing film than comparable containers lacking the texturized surface(s).

For many years, food items such as cuts of beef, pork, and poultry have been wrapped in foamed plastic (typically polystyrene) trays which were over-wrapped using a plastic cling film of the sorts often used in food service applications. Likewise, loose items such as fruits and vegetables (e.g., berries, green beans, or peaches) and seafood (e.g., shrimp and clams) have been sold at retail outlets in plastic-film-wrapped paperboard or foamed-plastic containers. Desirably, the paperboard or foamed plastic containers exhibit sufficient rigidity to facilitate shipping and handling of the contents in commercial and retail distribution environments, and the cling-wrap component prevented the contents of the container from being lost or becoming soiled or contaminated during shipping and handling.

Film-wrapped paperboard and foamed-plastic containers of this type have been used for many years and continue in common use. However, users of these containers recognize that solid (i.e., non-foamed) plastic containers exhibit many advantages over the foamed-plastic and paperboard containers typically used. Solid plastic containers—unlike foamed-plastic containers or soiled paperboards—are widely accepted in programs for recycling consumer waste. Unlike paperboard containers, solid plastic containers do not soften or weaken if exposed to moisture. Solid plastic containers can also be readily manufactured in shapes and sizes adapted to fit items to be packaged. For example, they can be made to specifically fit and/or cradle shaped items such as meatballs or poultry parts and to have compartments to accommodate fluids exuded from or condensed upon the packaged items. If clear and/or tinted plastics are used to make them, the resulting solid plastic containers can enhance the visibility and/or presentation of the packaged items. For these and other reasons, there are significant benefits to using solid plastic containers, wrapped or sealed with flexible (usually clear) plastic films for packaging items.

Early experience with plastic-wrapped solid plastic containers has revealed that such containers tend to exhibit a far greater incidence of tears and holes in the plastic films used to wrap and/or seal the containers than was observed when foamed-plastic or paperboard containers of the same or similar shapes were used. Such tearing and rupturing of sealing film has substantially limited use of solid plastic containers and prevented realization of their benefits. A desire to reduce the incidence of film tears and ruptures motivated the research and experimentation which resulted in this disclosure.

It has, surprisingly, been discovered that many of the tears and ruptures which occur in plastic films used to seal solid plastic containers can be avoided through the simple expedient of imparting a “rough” texture to the surface of the plastic container, at least a positions where the sealing film can be expected to contact the surface of the plastic container, rather than permitting the surface to retain a “smooth” surface texture that permits the plastic film to “wet” completely against the surface. This is, of course, contrary to “common sense” understanding that roughening a surface will tend to increase friction and inhibit lateral movement across or along the surface.

Without being bound by any particular theory of operation, it is believed that it was previously not appreciated that at least some of the reasons why film-wrapped containers made from paperboard or foamed-plastics exhibited beneficial properties are attributable to the ability of the film to “slip” across the surfaces of those containers without binding strongly thereto. By contrast, it has been discovered that relatively “smooth” surfaces of solid plastic containers “wet” with plastic films applied against them, enabling stronger bonding of the film with the container surface, and thereby inhibit the ability of the film to slip across the surface. When slipping of the film across the surface is inhibited, frictional or other forces incident upon the film can be localized at small portions of the film, enabling relatively small applied forces to act in a concentrated fashion upon the film and stretch or tear it far more than would be possible if the applied force could be dissipated by slippage of the film across the plastic container surface. Texturization of the solid plastic container surface replicates the relatively “rough” surfaces of paperboard and foamed plastic containers and weakens film-to-solid-plastic-container interactions, enabling greater slippage of film across the surface and relief of applied stresses.

Texturization of solid-plastic container surfaces therefore permits the many benefits of solid-plastic containers to be realized while conferring to solid-plastic containers features that have long been recognized as desirable for paperboard and foamed-plastic containers wrapped or sealed with plastic films.

### Definitions

As used herein, each of the following terms has the meaning associated with it in this section.

“Cling film” means any of a variety of plastic films used to wrap containers for containing food or other items, the film having at least one face (typically the face opposed against the container and/or its contents) which exhibits sufficient tackiness (or “clinginess”) to adhere to itself and/or the container when the container is over-wrapped with the film.

“Wetting” means the affinity of a plastic film to spontaneously make intimate contact with a substrate surface when a sheet of the plastic film is simply laid atop the substrate surface or urged (e.g., with gentle finger pressure, such as less than one pound per square inch) compressively against the surface. In this context, “intimate contact” means that the surface of the plastic film facing the substrate directly contacts the surface of the substrate facing the film without a continuous interposed layer of air (or other gases, although isolated pockets or ‘bubbles’ of gas may be present).

The “wetted fraction” of a plastic film opposed against a substrate over a selected region means the area of the film's substrate-facing surface that is in intimate contact with the film-facing surface of the substrate within the region, divided by the total area of the film's substrate-facing surface within the region.

### DETAILED DESCRIPTION

The subject matter described herein relates to technology for rendering solid plastic containers (e.g., plastic trays) amenable to slippable contact with plastic films, especially tacky or clingy plastic films such as common cling films used for wrapping foods and other items.

By conferring a texture (“texturizing”) to one or more portions of the container that contacts the film (a “film-contact surface” of the container), the tenacity with which the film binds with the container can be significantly decreased. Decreased binding tenacity permits plastic films to slide or skip across the surface of a container, rather than being relatively rigidly anchored to the container. Such film movement can prevent tears, leaks, stretches, holes, and ruptures that might otherwise occur in a film wrapped around a container.

It is widely known and believed that less frictional resistance will be encountered when a material is slid along a smooth surface than a rough one. Counterintuitively, however, it has been found that increasing the “roughness” of certain plastic materials results in a significant decrease in sliding resistance when cling-type films are slid along their surface.

This discovery has herein been put to practical use in the field of packaging foods and other items in containers which are sealed with plastic films. By way of example, it is common to package cuts of beef, pork, or poultry atop trays for retail sale, the trays being over-wrapped with a cling film both to contain the meat and fluid (“purge”) which issue from the meat and to prevent transfer of bacteria, viruses, filth, and other materials between the meat and the retail environment. Cling films typically do not bind to paperboard and foamed plastic trays or, if they bind, they bind with relatively little tenacity. Hence, interactions between plastic wrapping films and packaging trays has not been considered a “problem” and has garnered relatively little interest.

For a variety of reasons, demand has grown for use of packaging trays made of a single polymer species (e.g., PET, polyethylene (PE), or polypropylene (PP)) in a non-foamed (i.e., solid) form or from multiple discrete layers of non-foamed homopolymers. Cling films tend to bind more tenaciously to the surfaces of such solid plastics. Relatively tenacious binding can be beneficial for adhering cling films to such trays, for example, and solid plastics are readily recycled in common recycling programs. However, it is believed that the relative tenacity with which cling films bind with solid plastics may be responsible for the significantly greater incidence of tears, leaks, and ruptures experienced by users of solid plastic trays. These drawbacks can be reduced or eliminated by texturizing the surface(s) of solid plastic trays which contact cling films (and other plastic films) as described herein.

Solid Plastic Containers

Containers for segregating, supporting, or enclosing articles for storage, display, and/or transportation are among humankind's oldest technologies. Apart from stone tools, shards of containers made of pottery represent some of the earliest human artifacts. The rise of modern commerce has led to an explosion in the number of containers used and the volume of materials used to make those containers. The overwhelming number of containers for individual products (or small numbers of products) are used only once—especially containers for products for which sanitation is a primary concern, such as food containers.

The large numbers of containers that are required in commerce lead to twin problems: first, how to make so many containers practically and economically; and second, how to dispose of so many containers after use in a manner that does not adversely affect human social environments and natural environments (e.g., rural areas). Packagers have found it relatively simple and cheap to make containers from wood fibers (e.g., paper, paperboard, and cardboard) and from plastics (e.g., solid plastics, foamed plastics, and agglomerations of foamed plastics). However, disposal of the expanding volume of waste containers presents increasing difficulties.

Wood fibers can be recycled or composted. However, most recycling operations will not accept wood fiber materials contaminated with food or other wastes, and recycled wood pulp has limited value. Non-recyclable wood fiber containers (and many recyclable ones as well) are sent to landfills or incinerated. Foamed plastics are difficult to recycle and are likewise not accepted by many recycling operations; they, too, are typically landfilled or incinerated. Solid plastic materials are widely accepted by recycling programs and can be readily recycled into feedstock materials having significant value. Increasingly, solid plastic containers are viewed as a sustainable option to formerly single-use containers.

This disclosure focuses on use of solid plastic containers for foods and foodstuffs that are used together with thin plastic films such as cling films. However, the technologies disclosed herein can be used to make substantially any solid plastic container compatible with clingy plastic films contacted or stretched against them in situations in which slippage of the plastic film across the surface of the plastic container is considered desirable.

The size, shape, and conformation of the solid plastic container are largely immaterial to the subject matter described herein, except as these features influence the surfaces of the container that will contact (or are likely to contact) a plastic film during filling, closure, shipping, handling, or storage. Thus, containers can have the physical shape of trays, bowls, platters, platforms, carriers which conform to the shape of articles to be contained therein (e.g., trays for containing hamburger or turkey patties, meatball, hen or duck eggs, or the like), clamshell packages, or other shapes. Particularly preferred are containers in the form of rounded rectangular trays having peripheral edges that have been rolled over to yield a smooth periphery, such as those described in U.S. Pat. No. 10,076,865 to Wallace. Numerous container shapes and sizes are known in the art to be useful for wrapping or sealing with plastic films, and the subject matter described herein can be applied to substantially any film-contacting surface of such containers. The surface-texturization described herein should not be used at surfaces (e.g., sealing or adhesion surfaces) at which close and/or tenacious binding of film to the container is desired.

The material from which the solid plastic container is made is not critical. The effects described herein are believed to be applicable to substantially any solid plastic material useful for forming containers having film-contacting surfaces. Nonetheless, the technologies described herein were developed with containers made from PET in mind, so that tray-shaped PET containers could be used together with existing cling films (e.g., PVC and LDPE films) in place of similarly-shaped paperboard and foamed plastic trays which have long been used together with those films. The technologies are also useful for forming containers made from other polymers, such as polyethylene, polypropylene, and biodegradable polymers.

Cling Film

Plastic films are commonly used to seal containers which contain foodstuffs (e.g., cuts of meat, fruits, berries, vegetables, or grains) or non-food items. The inexpensiveness, flexibility, and ease of handling of such films renders them practical for many such applications. Particularly useful for sealing are films which exhibit sufficient tackiness or clingy-ness that the film will remain attached (i.e., “cling”) to itself or to a glass, plastic, or metal surface after it has been pressed against it. By way of example, SARAN (TM) brand plastic wrap and REYNOLDS WRAP (TM) brand plastic wrap are common consumer products marketed for this purpose. Similar products are used commercially for food- and other product-wrapping purposes.

Cling films are typically made from one or more of polyvinyl chloride (PVC), polyvinylidene chloride (PVDC), or low-density polyethylene (LDPE). Additives (generally referred to as plasticizers or tackifiers) are generally included to enhance tackiness of films in which they are incorporated by enhancing the flexibility of the film and its ability to conform to surfaces which it contacts. By way of example, one or more adipate, phthalate, or terephthalate additives (e.g., di □(2 □ ethylhexyl)adipate (DEHA)) are commonly added to PVC films to enhance their tackiness, and additives such as liquid polybutenes or isobutenes are commonly added to LDPE films for the same reason. Without being bound by any particular theory of operation, it is generally believed that the tackiness attributable to cling films stems from the molecular structure of the polymers used to make them, which consist of tightly bound and coiled polymer backbones. The polymer backbones, rendered more flexible and deformable by the additives, are able to “wet” to surfaces to which the polymer mass can be closely opposed. PVC and PVDC also possess significant dipole moments, attributable to the chlorine atoms along their backbones, which gives them the ability to bind particularly tenaciously with dipole-bearing substrates (e.g., PET). The wetting capacity of cling film polymers are believed to make intermolecular attractions (i.e., van der Waals forces including London dispersion forces and dipole-dipole interactions) important contributors to the tackiness of cling films, at least for closely-bound substrates.

Cling films have long been used together with paperboard and foamed plastic trays, such as foamed polystyrene trays. Moreover, packaging operations which involve sealing items within or upon such trays using cling film are well-established and routine. For a variety of reasons, many packagers seek to replace paperboard and/or foamed plastic trays with trays made from formed pieces of solid (i.e., not foamed) plastic. For example, FIGS. 5A-5C illustrate a tray made from a unitary sheet of polyethylene terephthalate (PET) which is readily recycled and which can be sealed using plastic films in a variety of ways, including by over-wrapping it with a cling film.

A difficulty that has been encountered when solid plastic trays are sealed (e.g., over-wrapped) with cling film is that sealed trays tend to develop significantly more frequent leaks, tears, and other failures of the film. Such film failures can result in loss of film barrier integrity, product contamination, loss of segregation of the packaged product(s), leakage of package contents, or other unfavorable events. Reduction or elimination of these film failures would ease the transition from trays made of wood fiber or plastic foam to simpler-to-handle and more-recyclable solid plastic trays. The surface texturization described herein achieves this.

Sheets of each of PVC, PVDC, and LDPE are believed to exhibit significant attraction to PET surfaces. When a PET surface is brought into close opposition with a surface made of one of those polymers, significant attractive forces are exerted upon the two surfaces, tending to draw them together and increase the slip-resisting forces which oppose lateral movement of the two surfaces relative to one another. Cling sheets made from these materials (and others) are also known to exhibit significant attraction to other plastic surfaces, and it is expected that the surface texturization described herein can also be used to reduce slip-resisting forces which oppose slippage of cling films across those other plastic surfaces as well.

While not being bound by any particular theory of operation, it is believed that the increase in film failures arises from the tendency of cling films to bind relatively more tenaciously to surfaces of solid plastic trays than the same cling films bind to paperboard or foamed plastic trays. Texturization of surfaces of solid plastic trays reduces the tenacity with which cling films bind with those surfaces. This effect is believed to be substantially independent of the materials of which the solid plastic tray and the cling films are made (although the magnitude of the effect may vary). For this reason, the surface treatment methods and surface textures described herein are believed to be of broad applicability in the field of rendering solid plastic container surfaces slidably opposable against thin plastic films. Use of solid plastic containers having texturized cling-film-contacting surfaces is nonetheless believed to be a particularly useful application of the subject matter disclosed herein.

Surface Texture

It has been discovered that texturizing the surface of a solid plastic against which the face of a plastic cling wrap sheet is opposed can significantly reduce the tenacity with which the cling wrap binds with the solid plastic surface. This is beneficial for permitting the over-wrap of a cling-film-wrapped package to slip laterally along solid plastic surfaces within the package, such as the edges or a support surface of a solid plastic tray used to support or contain a packaged article.

Increasing roughness of a surface typically increases the coefficient of static friction (CSF) for a material dragged across the surface. However, it has surprisingly been discovered that, regardless of whether texturization of a solid plastic container surface increases or decreases CSF, the decrease in attractive force brought about by texturization of a cling film-contacting plastic container surface greatly outweighs any contribution of frictional resistance to slippage of the film across the surface.

This effect is believed to be significantly attributable to the ways in which cling films interact with solid plastic substrates, such as smooth surfaces of packaging trays made from PET, PE, or PP. FIGS. 18 and 19A-19C illustrate interaction of a plastic sealing film 650 with a portion 30 of a solid plastic container. The substrate-facing face 651 of the cling film 650 contacts the film-contact surface 31 of the container portion 30 (i.e., the film-facing surface of the substrate). Wavy lines in FIG. 18 indicate that other portions of the cling film and the container are not shown. The dashed box in FIG. 18 indicates a plane further detailed in FIGS. 19A-19C. FIG. 19A is diagram which shows forces acting upon the film 650 and container 30 at their interface. FIGS. 19B and 19C show potential macroscopic effects of these forces upon movement of the film laterally across the surface 31.

In FIG. 19A is shown a formula for calculating the “force of friction” (Ff) between container surface 31 and the substrate-facing face 651 of the cling film 650 prior to commencing sliding movement relative to each other. It is recognized that friction is not really a “force,” but is instead a quantity that describes the amount of force that must be applied to the film in order to overcome all factors inhibiting commencement of movement. All references herein to “friction” relate to static friction, rather than kinetic friction. Per the Coulomb formula, Ff is equal to the product of a constant (the coefficient of static friction; here “Kcsf”) and the sum of all forces normal to the sliding surface. Four contributions to normal force are shown. Fg represents the force of gravity, whether acting upon the film resting upon the container, as shown, or (not shown) acting upon the container resting upon the film. Fc represents compressive force which urges the film toward the container (examples of Fc potentially include tension induced in the film by tight wrapping, items stacked atop the film-wrapped container, or incident force of an external object impacting upon the film-wrapped container). Fp represents a gas pressure force, equal to the difference in pressure between the space outside the film-container interface and the space (if any) within the film-container interface (a positive pressure difference will tend force the two apart; a negative pressure difference will act like an additional component of compressive force, Fc). Fa represents the force of attraction exerted by the film and the container upon each other.

Following the analog of Coulomb's formula shown in FIG. 19A, Ff is equal to the sum of Fg+Fc+Fp+Fa, multiplied by constant Kcsf. Turning to FIG. 19B, it can be seen that if the force F applied to film 650 in the lateral direction is greater than Ff, the film will slip (displace) laterally relative to the container portion. (Elastic deformation of film 650 is not depicted in FIGS. 19B and 19C for the sake of simplicity; the result shown in the figures would be equivalent to the state after force F is applied and then released). However, such lateral displacement will occur only if Ff is less than the yield strength (Fy in FIG. 3) for the film 650. FIG. 19C illustrates the consequence if Fy is less than Ff—the film will undergo necking and/or drawing. If, as shown in FIG. 3, additional strain beyond Fy does not result in hardening of the film material, then continued application of force F to the film will continue thinning, and ultimately fracture, the film. If the material exhibits strain hardening, then lateral movement will commence if strength of the strained material rises above Ff. FIGS. 19A-19C therefore illustrate how “too-tenacious” binding (i.e., Ff>Fy) can lead to permanent adverse changes (stretching, thinning, breaches, fractures) of the film. Lowering the “force of friction” (i.e., encouraging slippage of the film against the container) permits the film to move (as in FIG. 19B), rather than being damaged (as in FIG. 19C). Significantly, the magnitude of Ff (i.e., the tenaciousness of binding) can be lessened by decreasing one or both of Fa and Fp. Surface texturization of the container surface can achieve both of these ends.

Decreasing Surface Attraction Between Cling Film and Plastic Container Surfaces

Cling films are characterized by their ability to “wet” and cling to a variety of substrates. Film wetting brings the film material into close contact with its substrate. Close contact between surfaces can give rise to significant contributions from van der Waals interactions between the surfaces. For example, even ignoring potential dipole-dipole interactions, others have calculated that two planar surfaces which contact one another at an intermolecular distance of about 0.2 nanometers exert attractive force equivalent to about 7000 atmospheres (7×10\hat{ }8 Newtons per square meter), falling to about 0.05 atmosphere at an intermolecular distance of about 10 nanometers. Israelachvili, Intermolecular Surface Forces, 2d ed., Academic Press, 1991, pp. 176-179. Dipole-dipole interactions (e.g., between solid PET substrates and PVC-based cling films) can be expected to contribute significantly to van der Waals forces as well.

Even taking into account that cling films will not be able to precisely match the surface topography of a plastic substrate, it can be appreciated that even relatively small areas of close inter-surface contact can contribute significantly to attractive forces between opposed faces of a cling film and a solid plastic substrate. While not being bound by any particular theory of operation, it is believed that the surface texturization described herein disrupts a significant fraction of intermolecular attractions which result from close surface-to-surface binding interactions between a cling film and a solid plastic surface. By maintaining separation between cling film and solid plastic substrate surfaces, the surface texturization reduces the magnitude of van der Waals intermolecular interactions between the surfaces, reducing the normal force component of Coulomb's equation for frictional force, thereby reducing the amount of force that must be applied to the film in order to overcome all factors inhibiting commencement of movement. Restated more succinctly, texturization of the surface eases lateral movement of the film across the substrate.

In practice, the type and extent of solid plastic substrate surface texturization necessary to reduce the tenacity of cling wrap binding reduces to reducing the faction of the substrate surface at which the film is able to contact the surface closely enough for van der Waals forces to have a significant magnitude. This is shown diagrammatically in FIGS. 21A-21D. FIG. 21A depicts a square portion of the substrate-facing face 651 of a cling film, sub-divided into 100 smaller squares in a 10×10 grid. In FIG. 21A, all smaller squares are empty, signifying that no portion of the film is closely enough bound with the film-facing surface 31 of the solid plastic substrate 30 for van der Waals interactions to be significant. In FIG. 21B, by contrast, the substrate-facing face 651 of the cling film is closely bound with the substrate at 20 of the 100 smaller squares (on account of the texture present at the substrate face 31), meaning that only one-fifth of the total surface is closely enough bound for van der Waals interactions to be significant. Similarly, in FIG. 21C, cling film is closely bound at 20/100 smaller squares, albeit in a different pattern (attributable to a different surface texture) at substrate face 31. In the case of each of the films depicted in FIGS. 21B and 21C, the contribution of attractive forces to the normal force component of Coulomb's equation for Ff should be about one-fifth the contribution attributable to complete surface binding (i.e., 100/100 squares closely bound) of the film 650 to the substrate 30. By comparison, the film depicted in FIG. 21D (80/100 squares closely bound) should be expected to contribute about 80% of the contribution attributable to complete surface binding. These figures illustrate that reducing the fraction of the film surface that is able to closely bind to the substrate surface can be expected to ease lateral movement (i.e., slipping) of the film along the substrate surface.

FIGS. 20A-20E illustrate several substrate surface texture profiles for the purpose of suggesting the effect that the various textures can be expected to have on the tenacity of cling film binding to the substrate. In each of FIGS. 20A-20E, a cross-sectional view of the interface of a cling film 650 and a solid plastic substrate 30 is depicted.

FIG. 20A depicts a solid plastic substrate having a completely flat, planar film-contact surface 31; the film 650 closely opposes against the substrate over substantially the entire interface shown. If this close opposition occurs across the film-contact surface 31, then the contribution of van der Waals attractions is approximately at a maximum value for this film/substrate combination.

By contrast, FIG. 20B depicts a solid plastic substrate having a fairly regular array of dome-shaped protrusions or ridges extending therefrom at its film-contact surface 31. Because the protrusions are spaced closely enough that the film 650 cannot substantially sag or extend between the protrusions/ridges, only about one-half of the substrate-facing film surface 651 is able to contact the film-contact surface 31. Accordingly, if this pattern were representative of the entire film-contact surface 31, then the magnitude of van der Waals attractions would be expected to be roughly one-half (assuming the dome-shaped objects are ridges; less if they are protrusions having a circular conformation, like inverted flower pots) of that shown in FIG. 20A.

FIG. 20C depicts a solid plastic substrate having a more varied array of protrusions, with only a relatively small number contacting the film 650. The contribution of van der Waals attractions would be expected to be substantially lower than for the film/substrate combination shown in FIG. 20B. In the plane normal to the page, the pattern of contact between the film 650 and the film-contact surface 31 of the substrate might be expected to resemble that shown in FIG. 21B.

FIGS. 20D and 20E illustrate that textural feature spacing, textural feature topology, and film conformability to the textured surface can vary, and that the ability of the film to ‘sag’ (conform to the textural features) can affect the degree to which the film 650 can be expected to closely oppose against the film-contact surface of the substrate 30.

As illustrated in FIGS. 20A-20E, the precise pattern and density of the texture imparted to the film-contact surface is less important than the fraction of the substrate-facing film surface that is able to closely bind against the film-contact surface. The greater the fraction of film surface that is able to bind closely, the greater the contribution of van der Waals (or other surface) forces to binding tenacity (and resistance to film slippage) can be expected to be. The texture can, for example, be a repeating pattern on the film-contact surface of the solid plastic substrate, such as rows and columns of hump-shaped protrusions or ridges arranged in regularly-spaced “star-burst” type patterns. Alternatively, the texture can be random, such as the pattern generated by impact of particles (e.g., beads, mineral grains, or other materials) upon the surface.

The texture at the film-contact surface of the container can be imparted directly upon the container (e.g., by spattering material upon the film-contact surface to form the contours of the texture, or by impacting particles against that surface). More practically, the texture can be formed simultaneously with molding or forming of the container, for example, as shown in FIGS. 23A-23C using a single mold (or other) surface applied against one face of the plastic substrate, and as shown in FIGS. 23D and 23E using a pair of molds applied against opposite faces of the substrate. Solid plastic containers are typically made using a mold, whether through thermoforming, by injection molding, or by other means. The texture can be imparted to the container by incorporating the texture into one or more surfaces of the mold, for example. The film-contact surface can be the same surface that contacts the mold or, if the thinness of the plastic material and the processing steps permit, the texture can be formed on the face of the container opposite the face that contacts the mold surface. As another alternative, a substrate sheet that is thermoformed to generate the container can have the texture imparted to it prior to thermoforming (taking care that the texture is retained through the thermoforming process). As yet another alternative, containers can be generated by three-dimensional printing or other additive methods, or the texture can be additively printed or deposited upon container surfaces. As still another alternative, a strike plate having a textured surface can be applied against the face of a softened plastic substrate (i.e., one heated above its glass transition temperature), even if the strike plate does not change the overall shape or contour of the substrate. For example, a textured strike plate may be contacted against an in-mold substrate sheet, with the textured surface contacting the substrate at the face opposite the mold-contacting face of the substrate.

The placement or position of the textured surface upon the container is important, in that it is desirable that the texture be present at surfaces at which the plastic film is expected to contact the container surface. FIGS. 5A-5C, 6A-6C, and 7A-7F illustrate a common tray having a flat base, flat vertical sides joined to the base by curving side edges and faceted corners, and a flat peripheral rim surrounding the tray's compartment. The peripheral edges of the rim are curled under the surface of the rim so as to present a smooth peripheral surface at the lateral edge of the rim. Two “L”-shaped legs extend inwardly (into the compartment) at each side. In the center of the compartment, a rounded rectangular ‘text plate’ section of the tray base is indented toward the interior of the compartment; the tray rests on flat surfaces upon the rounded rectangular base that surrounds the text plate.

The tray shown in FIGS. 5A-5C includes no textured surface.

FIGS. 6A-6C show a tray that is anticipated to be over-wrapped with a sheet of cling wrap after items have been placed in the tray's compartment. Stippling shows the surfaces of the tray which are texturized to reduce the tenacity of binding between the cling wrap and the tray. When the tray is wrapped, the cling wrap is expected to directly contact the flat upper surface of the rim, the curled outer edge of the rim, the exterior portions of the curved side edges and faceted corners, and the exterior portions of the flat base portion. Portions of the tray that are not stippled in FIGS. 6A-6C are not expected to contact the film when the tray is wrapped; these portions include the underside of the rim. the interior of the compartment, the underside of the text plate, and the exterior portions of the sidewalls above the curved edges and faceted corners. These portions need not be textured in order to reduce cling film binding tenacity; some or all of them can be so textured if desired.

FIGS. 7A-7C shows another tray which differs from the tray shown in FIGS. 6A-6C in that the upper surface 52 of the rim 104 has not been texturized. Such a tray would be useful if close opposition of a plastic sheet against the peripheral edge of the rim were required (e.g., for sealing the sheet thereto) and an item contained within the hollow of the tray would ordinarily be expected to elevate the plastic sheet above the surrounding flat portion of the rim 104. If a sheet of cling wrap were sealed to the peripheral edge 191 of the rim of this tray (and the exterior surface of that cling wrap did not include a protective layer, such as a nylon layer), the texturing of the external portion of the tray can serve to reduce the likelihood that the cling wrap of one such tray will bind tenaciously with an exterior surface of a second such tray. This illustrates that the surface texturization can be used to regulate not just the interactions of a tray with a cling wrap associated with that same tray, but also the interactions of solid plastic surfaces of one tray with a cling wrap (or other plastic film) associated with another tray.

FIGS. 7D-7F shows yet another tray which differs from the tray shown in FIGS. 6A-6C in that the bottom portion of the tray is not texturized, while upper surface 52 of the rim 104 is texturized. Such a tray would be useful if close opposition of a plastic sheet against the upper surface 52 of the rim were required (e.g., for sealing the sheet thereto) and an item contained within the hollow of the tray would not ordinarily be expected to elevate the plastic sheet above the surrounding flat portion of the rim 104. If a sheet of cling wrap were sealed to the upper surface of the rim of this tray (and the exterior surface of that cling wrap did not include a protective layer, such as a nylon layer), the texturing of the flat portion of the tray rim can serve to reduce the likelihood that the cling wrap of one such tray will bind tenaciously with an exterior surface of a second such tray. This also illustrates that the surface texturization can be used to regulate the interactions of solid plastic surfaces of one tray with a cling wrap (or other plastic film) associated with another tray. As can be seen in FIG. 7F, it is ordinarily not necessary to texturize the peripheral edge 110 of the substrate sheet 101 from which the tray is formed, at least when that edge is rolled over as in this tray, because that edge and the portion of the substrate sheet immediately adjacent it will normally not contact a plastic film used to seal the tray.

Textures can be applied to multiple faces and/or regions of a plastic substrate sheet during and after molding. By way of example, FIG. 22A-22G depict a process (disclosed, for example, in U.S. application Ser. No. 16/212,846 to Wallace) in which one or more core mold elements 710 contact the inner surface of the compartment of a tray-shaped container, while one or more peripheral mold elements 720 contact upper- and outer-surfaces of the container, and one or more ram elements 300 or strike plates 750 contact the opposite face of the substrate sheet at the same or different regions of the formed container. Any of the mold/ram/strike-plate surfaces that contact the plastic substrate sheet 101 can be used to impart a texture thereto, such as any of the textured-surface combinations disclosed herein.

Facilitating Pressure Changes at Cling Film—Plastic Container Interfaces

When a film is disposed parallel to and along a surface, there can be a layer of gas interposed between the film and the surface, for example as shown in FIG. 18. Assuming no lateral flow of gas along the surface, increasing the distance between the film and the surface will increase the volume of this ‘gas layer’ space and (when there is no such lateral flow of gas), decrease the pressure of the gas within the space by causing the same amount of gas to fill a larger volume. When the gas pressure outside the space (i.e., above surface 653 in FIG. 18) is initially equal to the gas pressure within the space (i.e., between surfaces 651 and 31 in FIG. 18), an effect of increasing the distance between the film and the surface will be that a pressure difference will occur across the film. The net effect of such a pressure differential across the film is that the film will experience force (Fp in FIG. 19A) attributable to the gas pressure difference. If the pressure between the surface and the film is greater than the pressure on the opposite face of the film (outside the package; Fp has a negative value), Fp will tend to force the film and the surface apart, reducing friction resistance to lateral movement of the film across the surface (Ff in FIG. 19A). Conversely, if the pressure between the film and the surface (e.g., within a film-sealed container) is less than the pressure on the opposite face of the film (outside the film-sealed container), then Fp will have a positive value, meaning that the film will effectively be urged against the surface, and Ff will accordingly take on a greater magnitude.

The degree of pressure change which occurs upon changing the separation distance between the film and the container surface will depend significantly on at least two factors: the amount of gas initially present between the film and surface and the ability of gas to flow to the site of separation.

FIG. 20A depicts a film which is snugly opposed against a smooth section of tray surface. FIG. 20B depicts a film opposed against a ‘bumpy’ section of tray surface. Assuming a similar scale for the two figures, it is apparent that significantly more gas is present between the film and surface in FIG. 20B than in FIG. 20A. If the film 650 in FIG. 20B were separated from the surface 31 of the tray 30 by an amount sufficient to define a separation volume equal to the volume of gas initially present between the two, then the pressure would be expected to roughly halve (the same amount of gas filling twice the space). By contrast, if the film 650 in FIG. 20A were separated from the surface of the tray 30 by an amount sufficient to define a separation volume equal to that same volume (i.e., the volume of gas initially present between the film and surface in FIG. 20B), the pressure would be expected to be much lower (i.e., essentially no gas being forced to fill a relatively large volume). For this reason, a film displacement that urges the film against the surface would be expected to be resisted by far greater gas pressure force for the situation depicted in FIG. 20A than that depicted in 20B. Texturization of the container surface therefore increases the amount of gas initially present between the film and the container surface, facilitating deformations of the film which tend to pull it away from the container surface with reduced gas pressure force acting upon the film, relative to a film opposed against a smooth tray surface.

Texturization of container surfaces also has a second important contribution to lessening gas pressure. In the preceding paragraph, the examples were discussed assuming no gas flow along the surface of the container. However, such gas flow can significantly relieve pressure changes caused by deformations of the film toward or away from the surface. Considering the situation depicted in FIG. 20A, the close opposition of the film 650 against the substrate 30 effectively prevents much, if any, gas from flowing through this portion of the film-substrate package. If an area of the package is being disturbed in such a way that the film 650 is being urged away from the substrate in a portion of the package adjacent to that depicted in FIG. 20A, little or no gas is going to be able to flow through the film-substrate interface shown in FIG. 20A in order to relieve gas pressure changes associated with the disturbed portion. By contrast, the passageways which contain gas in FIGS. 20B and 20C can facilitate gas flow to an adjacent disturbed portion of the package (assuming those passageways fluidly communicate with the film-substrate interface in the adjacent disturbed portion). Texturization of the container surface therefore increases the amount of ability of gas to flow between the film and the container surface, facilitating deformations of the film which affect gas pressure.

In FIG. 1B, a second cling film-wrapped tray contacts the first. As with the first tray, the film (S2) of the second tray is opposed against the outer surface of the second tray (T2), and “lightning bolt” symbols again signify attractive force between the second tray and its enclosing film. The portion of the second tray depicted in FIG. 1B is disposed close enough to the first tray that the first tray's film (S1) is closely opposed against the second tray's film (S2). As is common with cling films, closely opposed sheets of the film strongly attract one another, and this is illustrated by the “lightning bolt” symbols interposed between sheets S1 and S2. The greater density of “lightning bolt” symbols between sheets S1 and S2 is meant to signify that the two sheets are attracted to one another more tenaciously than they are attracted to their corresponding tray surfaces. Furthermore, comparing FIGS. 1A and 1B, it can be seen that the density of “lightning bolt” symbols between T1 and S1 is decreased upon contact with the second tray; this is meant to signify that attraction between the films (S1 and S2) can pull film 1 away from T1, lessening the attraction (i.e., density of “lightning bolt” symbols) between T1 and S1 (compare lower “lightning bolt” symbol density between T1 and S1 adjacent the S1-S2 interface, relative to density on the right side of the figure). FIG. 1B illustrates the two film-wrapped trays upon contact and prior to relative movement shown in FIGS. 1C-1E. Two reference points (R1 and R2) are shown in FIG. 1B, representing, for R1, a location along film S1 to the right of which the film S1 binds relatively tenaciously to the tray T1 and, for R2 a location along film S1 to the left of which the film S1 binds relatively tenaciously to the film S2. A portion of film S1 between R1 and R2 does not bind tenaciously to either tray T1 or film S2, and has a length L prior to relative movement of the two trays.

The observations regarding the presence and flow of gas between the film and container surfaces has particular applicability to film/container packages which are sealed to a gas-tight or nearly gas-tight state. In such containers, a relatively fixed amount of gas will initially be present within the film at the time the package is sealed. If that pressure changes subsequent to sealing, the positions and conformations of the flexible sealing film and the container may be forced to change as well. Texturization of the container surface at portions at which the container contacts the film (either initially or subsequent to a pressure change) can facilitate slippage of the film along the surface(s) of the container at those film-contacting surfaces, reducing strain (and resulting stresses) upon the film and decreasing the likelihood and incidence of non-elastic film deformations and film ruptures.

As an example of the foregoing, imagine a spherical film “balloon” sealed at a pressure of 1 atmosphere. If the volume of the balloon at 1 atmosphere pressure is called “V,” then length of the radius “r” of the spherical balloon at this pressure is specified by geometry as the cube root of (0.75×pi×V). If the pressure within the balloon is doubled (or the pressure outside the balloon is halved, the ideal gas law specifies that the volume of the balloon will double, to 2V. The radius of the balloon at this latter condition is the cube root of (0.75×pi×2V)—a larger value. If a shallow square-rimmed tray having a diagonal, corner-to-corner distance equal to twice the radius of the balloon at the latter condition is disposed within the balloon at that latter condition, the four corners of the rim will just touch the balloon's edge if the tray is situated with is rim along the center of the balloon. If conditions are then brought to the former condition (i.e., lower pressure within the balloon or greater pressure outside of it), the balloon will shrink to its smaller volume and smaller radius, and portions of the balloon will contact and then rub against the rim of the tray as the balloon shrinks. If the portions of the tray contacted by the balloon as it shrinks are texturized as described herein, then the resistance to balloon slippage along the tray surface will be decreased, the balloon walls will be subjected to lesser strains values, and the balloon will be less likely to rupture, than if the tray rim surfaces were smoother.

Looking to a more realistic, but nonetheless similar, scenario, it is common to dispose foodstuffs (raw or cooked) into trays, bowls, or other containers which have rims or edges, and then to overwrap the container with a cling film so as to seal the foodstuffs and some atmospheric or other gas within the sealed film. It is also common to subsequently chill or freeze the foodstuff (to preserve it or to retard spoilage), and to subsequently ship, handle, and display such containers. Each of these post-sealing operations can subject the package to significant pressure changes attributable to heating or cooling of gas within the sealed package, resulting in relative movement of the film along the container surfaces contacted by the film. Each of these post-sealing operations can also subject the package to external stresses (e.g., bumping against surfaces of equipment or other packages or handling by people or machines) which likewise induce movement of the film along the container surface. If the film-contacting surfaces of the container are texturized, then slippage of film along the surface can occur with less resistance than if the same surfaces are smooth.

### EXAMPLES

The subject matter of this disclosure is now described with reference to the following Examples. These Examples are provided for the purpose of illustration only, and the subject matter is not limited to these Examples, but rather encompasses all variations which are evident as a result of the teaching provided herein.

### Example 1

This example relates to a situation in which a first product-containing tray, designated T1, that is wrapped with a cling film designated S1, interacts with another object that adheres to and damages the cling film. The object could be a container containing the cling-film wrapped tray such as the side of a cardboard shipping container, the wall of a plastic bin, a portion of a plastic bag containing the wrapped tray, or even a second cling-film wrapped tray. The examples illustrated in FIGS. 1A-1E, 2A, and 2B depict situations in which the object is a second cling-film-wrapped tray.

FIG. 1A is a cross-sectional view through the outer surface of an ordinary, smooth-surfaced plastic tray (T1). The straight edge of T1 indicates the outer surface, and the wavy lines of T1 indicate that the remaining portions of the tray are not shown in the figure. The cross-sectional view of FIG. 1A also shows a sheet of cling film (S1) opposed closely against the outer surface of T1. “Lightning bolt” symbols are interposed between T1 and S1 to indicate that attractive force exists between film S1 and tray T1, drawing the two toward one another. The approximately regular spacing of the “lightning bolt” symbols is meant to signify that this attractive force exists, approximately equally, across the interposed faces of T1 and S1.

In FIG. 1B, a second cling film-wrapped tray contacts the first. As with the first tray, the film (S2) of the second tray is opposed against the outer surface of the second tray (T2), and “lightning bolt” symbols again signify attractive force between the second tray and its enclosing film. The portion of the second tray depicted in FIG. 1B is disposed close enough to the first tray that the first tray's film (S1) is closely opposed against the second tray's film (S2). As is common with cling films, closely opposed sheets of the film strongly attract one another, and this is illustrated by the “lightning bolt” symbols interposed between sheets S1 and S2. The greater density of “lightning bolt” symbols between sheets S1 and S2 is meant to signify that the two sheets are attracted to one another more tenaciously than they are attracted to their corresponding tray surfaces. Furthermore, comparing FIGS. 1A and 1B, it can be seen that the density of “lightning bolt” symbols between T1 and S1 is decreased upon contact with the second tray; this is meant to signify that attraction between the films (S1 and S2) can pull film 1 away from T1, lessening the attraction (i.e., density of “lightning bolt” symbols) between T1 and S1 (compare lower “lightning bolt” symbol density between T1 and S1 adjacent the S1-S2 interface, relative to density on the right side of the figure). FIG. 1B illustrates the two film-wrapped trays upon contact and prior to relative movement shown in FIGS. 1C-1E. Two reference points (R1 and R2) are shown in FIG. 1B, representing, for R1, a location along film S1 to the right of which the film S1 binds relatively tenaciously to the tray T1 and, for R2 a location along film S1 to the left of which the film S1 binds relatively tenaciously to the film S2. A portion of film S1 between R1 and R2 does not bind tenaciously to either tray T1 or film S2, and has a length L prior to relative movement of the two trays.

In FIG. 1C, the second tray (T2 and S2) has been moved a distance equal to 0.2 L to the left, relative to its position in FIG. 1B. The portion of film S1 that is tenaciously bound to S2 to the left of reference point R2 moves together with the second tray. The portion of film S1 that is relatively tenaciously bound to T1 to the right of reference point R1 remains unmoved (as does T1). The portion of film S1 between reference points R1 and R2 stretches, with the distance between the two reference points lengthening to 1.2 L. As indicated for the point labeled “1C” in FIG. 3 (a stress-strain diagram for film S1), film S1 is undergoing elastic deformation in FIG. 1C. If the trays depicted in FIG. 1C were returned to the positions shown in FIG. 1B, film S1 would be essentially unchanged between R1 and R2.

In FIG. 1D, the second tray (T2 and S2) has been moved a distance equal to 0.5 L to the left, relative to its position in FIG. 1B. The portions of film S1 that is tenaciously bound to S2 also moves to the left, while the portion of film S1 that is relatively tenaciously bound to T1 remains unmoved (as does T1). The portion of film S1 between reference points R1 and R2 stretches, with the distance between the two reference points now lengthening to 1.5 L (i.e., 0.3 L longer than shown in FIG. 1C). As indicated for the point labeled “1D” in FIG. 3, film S1 has been stressed beyond its yield strength and is undergoing inelastic deformation in FIG. 1D. If the trays depicted in FIG. 1D were returned to the positions shown in FIG. 1B, film S1 would partially unstretch, but the distance between R1 and R2 will be greater than L (i.e., the film will have been inelastically stretched and will be thinned and deformed, relative to that shown in FIG. 1B).

FIG. 1E represents a further movement of the second tray to the left, while the first tray continues to remain stationary. The second tray has now been moved a distance of L to the left, while the portion of film S1 bound to S2 has moved with it. The portion of film S1 bound to T1 has remained stationary, with the result that reference points R1 and R2 are now a distance of 2.0 L from one another. As illustrated by the gap in film S1 in FIG. 1E, this movement has stretched the portion of film S1 between R1 and R2 beyond its fracture point, and the gap in film S1 has opened as a result. Film S1 has ruptured, or at least had a pinhole torn in it.

FIGS. 1A-1E illustrate an example of how film wrapping a smooth-surfaced tray can be torn by an object that contacts the film prior to or during relative movement of the tray and the object. Although the object illustrated in FIGS. 1A-1E is a second film-wrapped tray, the object could equally be packaging or handling equipment (e.g., the side rail of a conveyor belt upon which the tray is conveyed or the gloved hand of a human packer, grasping or moving the tray).

A diagrammatic representation of how the surface texturization described herein can be used to alter this behavior is shown in FIGS. 2A and 2B. FIG. 2A depicts the same two-tray arrangement shown in FIG. 1B, except that the attractive force between tray T1 and cling film sheet S1 has been significantly lessened. This is illustrated by way of the smaller number of “lightning bolt” symbols depicted between T1 and S1, indicative of lesser attractive force density or farther-apart spacing of areas of local attraction between T1 and S1. Accordingly, R1 (the point to the right of which sheet S1 binds relatively tenaciously to tray T1) is located substantially farther to the right than for the tray shown in FIG. 1B. The position of R2 is unaffected, with the result that the pre-movement distance between R1 and R2 is 5 L. This 5 L-long portion of film S1 is deformed when the second tray is moved 0.5 L to the left (as shown in FIG. 2B), with the result that the distance between R1 and R2 lengthens from 5 to 5.5 L (a strain value of 0.1).

In each of FIGS. 1D and 2B, the second tray has been moved 0.5 L to the left. For the tray shown in FIG. 1D, the strain induced by the portion of the film between R1 and R2 is 0.5 (lengthened from L to 1.5 L), and FIG. 3 (see point “1D”) indicates that inelastic deformation of film S1 has been induced. By contrast, for the tray shown in FIG. 2B, the same 0.5 L movement has induced a strain of only 0.1 (film stretched from 5 L to 5.5 L between R1 and R2), and FIG. 3 (see point “2B”) indicates that only elastic deformation of the film has occurred. Thus, by decreasing the attractive force between S1 and T1, or by spacing farther apart the areas at which such attraction occurs, the tray has been enabled to endure the same movement with significantly less stress imposed upon the film.

FIG. 4 shows an embodiment of the tray T1 in which this effect has been induced by disposing certain portions of tray T1 farther from cling film sheet S1 than other portions, which are nearer the film. By controlling the spacing of these ‘nearer’ portions, the spacing of regions at which the film binds relatively tenaciously to the tray can be modulated. Farther average spacing of the regions of attraction will tend to leave longer distances between immobilized portions of film S1, effectively distributing stain across longer segments of the film, reducing the stress induced thereby. Because the film will tend to be less stressed by equivalent movements, less inelastic deformation and or tearing of the film can be achieved.

### Example 2

In this example, over-wrappable meat trays having the same shape and conformation were made, the trays differing in their surface texture. One tray (the “smooth tray”) was made to have a relatively smooth texture over all of its surfaces, and the other (the “texturized tray”) was made to have a deliberately rougher texture over all of its surfaces. Each tray was made using a common thermoforming mold, as shown in FIGS. 8-10.

FIG. 8 is an overhead view of the face of each thermoforming mold. The smooth (S) mold on the left of the figure is a relatively standard aluminum thermoforming mold with a surface smoothness estimated at well over 240 grit (i.e., a smooth aluminum surface smoother than a normal satin finish, but not as smooth as a well-polished surface). The precursor of the texturized mold (T) on the right of the figure was essentially identical to the smooth mold prior to a surface texturization procedure. In that surface texturization procedure, the precursor was subjected to aluminum oxide particle blasting sufficient to roughen the surface to a texture approximately equivalent to 16 grit sandpaper. The surface texturization procedure was continued for a period and in directions deemed sufficient to impart a roughened texture to substantially every part of the texturized mold that was expected to contact a portion of a polymer sheet applied thereto that would appear in the finished tray, without significantly eroding or changing the macroscopic shape of any mold surface (i.e., its surface texture, and not its overall dimensions or shape, was changed). Aluminum oxide particles were used for texturization because aluminum oxide is believed to be normally present on aluminum surfaces owing to atmospheric oxidation of aluminum metal. Use of aluminum oxide particles for texturization therefore avoids introducing foreign substances onto mold surfaces, which can be important for hygienic reasons, especially when the mold is used to make containers used, for example, to contain human foodstuffs.

In FIG. 8, it can be seen that the surface of the smooth mold has the appearance of a smooth aluminum surface, while the surface of the texturized mold appears matte and/or granular. FIG. 9 is closer view of the corners of the molds shown in FIG. 8 and further illustrates the substantially “grittier” surface texture of the texturized mold, relative to the smooth surface of the smooth mold. FIGS. 10 and 11 are still-closer views of corner surfaces of the smooth (FIG. 10) and texturized (FIG. 11) molds. In FIG. 11, many pitted or faceted portions of the mold surface appear as light-colored “flecks.” Not readily visible in FIG. 8-11 are holes which extend through the mold. Such holes are useful for applying negative gas pressure (by way of channels connected to a vacuum source, for example) to a softened plastic sheet applied against the mold surface in order to draw the sheet surface snugly against the surface of the mold. These holes are commonly used in thermoforming molds and are understood by a skilled artisan in that field.

The molds were used to thermoform a PET sheet (23 mil thickness, food-container-grade PET material). The sheet was heated to a temperature at which it is softened (but not molten) and then applied against the rim-forming surface of the mold (i.e., the outer rounded-rectangular shape near the perimeter edge of each mold) while applying negative air pressure to the vacuum holes by way of internal channels not visible in the figures. The negative air pressure was relieved and the by-now-essentially rigid molded PET sheet was removed from the mold, with the shape of the molded tray embodied therein. Each of the smooth and texturized trays was trimmed from the non-molded portions of the PET sheet at approximately the lower outer extent of the rim portion. FIG. 12 illustrates the smooth (left) and texturized (right) trays that resulted from this process, each tray leaned against the mold used to form it. In FIG. 12, the smoothness of the surface of the smooth tray is evidenced by the distortion of the overhead light (a pair of fluorescent light tubes, about 6 feet long and 12 feet overhead) reflected by it. The irregularity of the surface of the texturized tray is evidenced by the diffusion of that same light.

FIGS. 13A and 13B are a pair of closer views of the upper surface (i.e., the face distal from the mold surface) of the (clear) smooth tray resting upon a black, fabric surface, with a panel of white LED lights illuminating the surface about 12 inches above the surface. FIG. 13A illustrates light reflection from the tray at a distance of about 18 inches from the tray. FIG. 13B is a closer view of the portion of FIG. 13A indicated by a dashed rectangle. The tray can be seen to have a very smooth, shiny surface, as highlighted by abrasions (arrows in FIG. 13B) made by rubbing the tray surface with a fine cotton handkerchief).

FIGS. 14A and 14B are a pair of closer views of the upper surface (i.e., the face distal from the mold surface) of the (clear) texturized tray resting upon the same black, fabric surface, with the same panel of white LED lights illuminating the surface about 12 inches above the surface. FIG. 14A illustrates light reflection from the tray at a distance of about 18 inches from the tray. FIG. 14B is a closer view of the portion of FIG. 14A indicated by a dashed rectangle. Rubbing the surface of this tray with the fine cotton handkerchief did not produce noticeable scuff marks.

Comparing FIGS. 13A and 14A, it can be seen that the surface of the texturized tray exhibits a “pebbly” texture, relative to the smooth surface finish of the smooth tray. Comparing FIGS. 13B and 14B further highlights the differences, with the pebbly texture of the texturized tray being more distinct, especially relative to the essentially featureless surface of the smooth tray.

FIGS. 15A and 15B compare the lower (i.e., proximal to the mold surface during thermoforming) surface of the texturized tray (FIG. 15A) and the upper (i.e., distal from the mold surface during thermoforming) surface of the texturized tray (FIG. 15B). Light is cast obliquely, at an approximately 45-degree angle, so as to highlight surface features. Steeply angled (relative to the planar floor of the tray) sides of surface features tend to appear white in these views. Surprisingly, the upper (distal) surface of the tray appeared to more closely resemble the textured surface of the mold than the lower (mold-facing) surface. The upper surface of the tray exhibited a granular, sharply peaked surface, much like the surface of the mold shown, for example in FIG. 11. By contrast, the lower surface, which was opposed against the mold face during thermoforming, appeared smoother than the upper surface. Whereas the upper surface was best characterized as a planar surface bearing relatively steep-sided peaks (albeit of low height), the lower surface was more nearly characterized as have a generally planar surface bearing smooth-sided pits, with some pits more steep-sided than others.

FIGS. 16A, 16B, 17A, and 17B illustrate the clarity of the trays and a surprisingly differential visual effect upon detail. FIG. 16A is a photograph of text viewed through the central portion of the smooth tray (the tray resting upon its base, upper side toward the camera). An arrow indicates a rounded corner of the text plate within the tray (the same corner shown in the dashed box in FIG. 13A. The text can be clearly read through the tray, with little distortion and with that distortion occurring primarily at molded in features, such as the edge of the text box and the curved bottom edge of the tray compartment. FIG. 16 B is a view of the same text, viewed through the central portion of the texturized tray (the tray resting upon its base, upper side toward the camera). Substantial distortion of the letters—especially the finer letters in smaller fonts—is seen, rendering the text difficult to read. Because clarity of trays is an important feature, this effect was initially troubling until an interesting visual effect was observed, as illustrated in FIGS. 17A and 17B.

FIGS. 17A and 17B illustrates view of two images viewed through the smooth (FIG. 17A) and texturized (FIG. 17B) trays (each tray resting upon its base, upper side toward the camera). Although some minor distortion of the images can be seen through the texturized tray (notice, for example, the portion of the cow's tail just above the switch, the cow's horns, and the legs and feet of the rooster), the images are otherwise essentially indistinguishable. This is despite the obvious distortion of letters by the texturized tray seen in FIG. 16B. Without being bound by any particular theory of operation, this effect is believed to be an artifact of the way the human brain interprets pictures (i.e., filling in missing parts and edges). Practically speaking, this effect suggests that the surface texturization described herein can be expected to preserve a substantial amount of image-type detail (e.g., visualizing a product such as a cut of beef or poultry through the tray); it may be inappropriate to position text such that it must be read through the texturized tray.

### Example 3

The following experiments were performed using the trays described in Example 2 to investigate their surface interactions with a commercial cling film (GLAD (RTM, The Glad Products Company, Oakland Calif.) brand Cling Wrap, clear food wrap, microwave-safe, BPA-free, obtained from a common retailer).

In each experiment, an approximately one-foot-square piece of the cling wrap was used. A portion, roughly two inches square, at a corner of the cling wrap piece was applied against a tray (or plastic sheet) surface and smoothed against the surface by application of normal swiping pressure (i.e., about the pressure that would normally be used to adhere an adhesive sticker to a surface) to urge the film against the plastic/tray surface using an index finger. The remainder of the cling film sheet was gathered into a ball and held in the fingers of one hand, while the thumb of that hand pressed firmly (estimated about ten pounds of force) against and approximately perpendicular to the smoothed film-on-plastic/-tray surface. The person holding the film in hand then attempted to “drag” the portion of the film between the thumb and the plastic/tray surface in the direction parallel to the tray surface while maintaining thumb pressure during the drag attempt. The person attempted to apply approximately equal thumb pressure for all plastic/tray surfaces tested.

The person reported that significantly less resistance to dragging the film across the surface was encountered when the surface was texturized (whether the surface tested was the mold-facing texturized surface or the opposite face). The person also reported that the resistance to dragging was approximately equal among: i) the mold-facing surface of the smooth (non-texturized) tray, ii) the opposite face of the smooth tray, iii) the PET sheet material from which both smooth and texturized tray was made (this sheet material was not subjected to tray-making processes), and iv) a smooth portion of a sheet trimmed from a texturized tray (i.e., a portion that had been heated and cooled equivalently to the texturized tray, but which had not been contacted with the texturized mold surface).

The person performing the tests was not able to conclusively distinguish between resistance to dragging the film across the surface of the texturized tray that was opposed against the mold during thermoforming and resistance to dragging the film across the opposite surface of the texturized tray. However, the person reported that the resistance seemed to be lower on the opposite (distal) face than on the proximal face. The difference (if any) in resistance between the two faces was substantially less than the difference in resistance between a texturized face and any not-texturized surface.

From these results, it was concluded that texturization of surfaces of PET trays reduces the resistance to slippage of cling film across such surfaces exhibited by the trays. Even though the resistance to slippage experiments described in this example were not formally quantified, the magnitude of the effect reported by the person described in this example, and confirmation of the effects by other persons performing equivalent experiments causes the applicant to recognize that the effect is significant.

### PARTS LIST

Unless clearly indicated explicitly or by context elsewhere in this application, the following is a list of indicia intended to correspond to parts or portions of the subject matter described herein.
10 shaped body of article
18 sidewall(s) of body 10 surrounding intracompartment orifice 106
19 sidewall(s) of body 10 surrounding compartment 105
30 film-contacting portion of solid plastic container
31 film-contact surface of container
32 short protrusion on surface 31
34 tall protrusion on surface 31
35 shallow indentation on surface 31
37 deep indentation on surface 31
50 extension
51 underside (bottom side or impact surface) of extension 50 and rim 104
52 upper surface (or sealing surface) of extension 50 and rim 104
100 article (formed from a thermoplastic material)
101 substrate sheet of article 100
102 mold-facing surface of substrate sheet 101
104 outer rim (surrounds compartment 105)
105 compartment
106 intra-compartment orifice (extends through substrate sheet 101)
107 inner rim (surrounds intracompartment orifice 106)
110 peripheral edge of substrate sheet 101
120 peripheral flange (part of deflectable flange 160)130 elbow (between peripheral flange 120 and spacer 140)
140 spacer of deflectable flange 160
145 rounded underside of the spacer 140150 bend region of deflectable flange 160 (between extension 50 and spacer 140)
160 deflectable flange
161 underside of the deflectable flange 160
162 junction (between body 10 and deflectable flange 160)
170 bent portion of deflectable flange 160 (i.e., bent after being deflected)
175 fused portion (of substrate sheet 101)
182 inner surface of transitional region 183
183 transitional region between floor 195 and sidewalls 19
184 outer surface of transitional region 183
185 chamfer at corner of compartment 105
188 leg
190 periphery of article
191 peripheral edge of outer rim 104
192 trans face of outer rim 104
193 cis face of outer rim 104
194 inner (within compartment 105) surface of sidewall(s) 19
195 floor of compartment 105
196 exterior surface of sidewall(s) 19
197 interior wall within compartment 105
198 text plate portion of floor 195
199 exterior surface of floor 195
500 liner sheet
510 peripheral edge of the liner sheet 500
600 lidding
610 peripheral edge of the lidding 600
650 Plastic sealing film (e.g., cling film)
651 Proximal face of sealing sheet 650 (proximal to sealed tray)
653 Distal face of sealing sheet 650 (distal to sealed tray)
700 thermoforming mold
710 core mold element
711 body-shaping surface
712 flange-shaping surface
715 slip joint
720 peripheral mold element
721 body-shaping surface
722 flange-shaping surface
723 ram-impact surface
730 substrate-shaping mold surface
731 textured mold surface
726 slot
750 strike plate
805 extension of deflectable flange surrounding intra-compartment orifice 106
810 peripheral edge of deflectable flange surrounding intra-compartment orifice 106
820 peripheral flange of deflectable flange surrounding intra-compartment orifice 106
850 bend region of deflectable flange surrounding intra-compartment orifice 106
861 underside of deflectable flange surrounding intra-compartment orifice 106
B point(s) at which bending is induced
S sheet
T tray

The disclosure of every patent, patent application, and publication cited herein is hereby incorporated herein by reference in its entirety.

While this subject matter has been disclosed with reference to specific embodiments, it is apparent that other embodiments and variations can be devised by others skilled in the art without departing from the true spirit and scope of the subject matter described herein. The appended claims include all such embodiments and equivalent variations.

1. A container for containing an article in a film-wrapped package at a handling temperature, the container comprising a substantially rigid thermoplastic sheet
formed into the shape of a container having
a base adapted to support the article and
one or more sidewalls which surround the base and are not coplanar with
the base, the sidewalls having an outer peripheral extent; and
bearing a texturized portion at a film-contact surface of the container.

2. The container of claim 1, wherein the texturized portion has a surface texture which wets with not more than 80 percent of the film surface that is opposed against the texturized portion when the container is wrapped with the film at the handling temperature.

3. The container of claim 2, wherein the texturized portion has a surface texture which wets with not more than 50 percent of the film surface.

4. The container of claim 2, wherein the texturized portion has a surface texture which wets with not more than 25 percent of the film surface.

5. The container of claim 1, wherein the texturized portion has a surface texture which wets with at least 20 percent less of the film surface than an otherwise-identical non-texturized portion.

6. The container of claim 5, wherein the texturized portion has a surface texture which wets with at least 50 percent less of the film surface.

7. The container of claim 5, wherein the texturized portion has a surface texture which wets with at least 75 percent less of the film surface.

8. The container of claim 1, wherein the texturized portion has a surface texture that facilitates free lateral gas movement along the surface when a gas-impermeable film is applied to the texturized portion.

9. The container of claim 1, wherein the texturized portion has a surface texture selected such that the frictional force opposing lateral slippage of the film at the texturized portion when the container is wrapped with the film at the handling temperature is reduced by at least 20 percent, compared with the frictional force opposing lateral slippage of the film at the texturized portion of an otherwise identical container having a substantially smooth texture at the texturized portion.

10. The container of claim 9, wherein the frictional force opposing lateral slippage is reduced by at least 50 percent.

11. The container of claim 9, wherein the frictional force opposing lateral slippage is reduced by at least 75 percent.

12. The container of claim 1, wherein the film is a cling film.

13. The container of claim 1, wherein the film is a PVC-based cling film.

14. The container of claim 1, wherein the film is an LDPE-based cling film.

15. The container of claim 1, wherein thermoplastic sheet comprises PET.

16. The container of claim 15, wherein the container has the conformation of a rectangular tray having rounded corners.

17. The container of claim 1, wherein the thermoplastic sheet bears a smooth peripheral edge.

18. The container of claim 17, wherein the peripheral edge of the tray is curled.

19. The container of claim 1, wherein the surface texture of the texturized portion is substantially isotropic.

20. The container of claim 1, wherein the surface texture of the texturized portion is an impression of a particle-blasted mold surface.

21. The container of claim 1, wherein the surface texture of the texturized portion is an impression of a machined mold surface.

22. The container of claim 1, wherein the surface texture of the texturized portion includes steep asperities over at least 10 percent of the area of the texturized portion.

23. The container of claim 1, wherein the container has the conformation of a tray, including
a substantially planar base,
a concavity adapted to contain the article atop the base, the concavity defined by sidewalls, and
a substantially planar rim enclosing the concavity and having an outer peripheral extent,
at least the outer peripheral extent of the rim bearing the texturized portion.

24. The container of claim 23, wherein the substantially planar rim is also texturized.

25. The container of claim 24, wherein the thermoplastic sheet is also texturized at the convex face of the concavity.

26. The container of claim 1, wherein the container has the conformation of a tray, including
a substantially planar base, and
a concavity adapted to contain the article atop the base, the concavity defined by the one or more sidewalls, at least the outer peripheral extent of the sidewalls bearing the texturized portion.

27. The container of claim 26, wherein at least a portion of the sidewalls opposite the face defining the concavity bears the texturized portion.

28. The container of claim 26, wherein at least a portion of the base bears the texturized portion.

29. The container of claim 1, wherein substantially all film-contact surfaces of the container bear the texturized portion.

30. The container of claim 1, having the article packaged therein within a film which over-wraps the container.

31-39. (canceled)
